(19) United States
(12) Patent Application Publication
(10) Pub. No.: US 2024/0174780 A1
(43) Pub. Date: May 30, 2024

(54) HOLLOW PARTICLES AND USE THEREOF

(71) Applicant: SEKISUI KASEI CO., LTD., Osaka (JP)

(72) Inventor: Yugo KATAYAMA, Osaka (JP)

(73) Assignee: SEKISUI KASEI CO., LTD., Osaka (JP)

(21) Appl. No.: 18/283,084

(22) PCT Filed: Mar. 22, 2022
(86) PCT No.: PCT/JP2022/013070

§ 371 Date: Sep. 20, 2023

(30) Foreign Application Priority Data
Mar. 23, 2021 (JP) 2021-048074

(51) Int. Cl. C08F 220/32; B01J 13/16; C08J 5/18; C09D 7/40; C09D 133/14; G02B 1/111; H01B 17/56

(52) U.S. Cl. CPC C08F 220/325; B01J 13/16; C08J 5/18; C09D 7/67; C09D 7/68; C09D 7/70; C09D 133/14; C08F 2800/20; C08F 2810/20; C08J 2333/14; G02B 1/111; H01B 17/56

(57) ABSTRACT

The present invention provides hollow particles that can suppress the occurrence of pinholes in shells and prevent the collapse of hollow portions due to deformation. The present invention specifically provides hollow particles including a shell and a hollow portion surrounded by the shell, wherein the shell contains a (meth)acrylic-based resin; wherein the hollow particles have an average particle diameter of 10 nm to 150 nm; wherein the hollow particles have a sphericity or 0.90 to 1.0; and wherein the hollow particles have a hollow ratio of 35% to 70%.

### TECHNICAL FIELD

The present invention relates to hollow particles and the applications thereof.

### BACKGROUND ART

Particles with internal voids are used as microcapsule particles by incorporating various substances into the voids. These particles with internal voids are also referred to as hollow particles and used as light scattering materials, low reflection materials, heat-insulating materials, low dielectric constant materials, or the like.

As hollow particles, for example, Japanese Patent Application Publication No. 2002-80503 (PTL 1) and Japanese Patent Application Publication No. 2005-215315 (PTL 2) disclose hollow particles obtained by preparing, in an aqueous solvent, oil droplets that contain a radically reactive monomer and a hydrophobic organic solvent with low compatibility to the polymer of this monomer, and subsequently polymerizing the monomer.

Japanese Patent Application Publication No. 2010-84018 (PTL 3) discloses organic-inorganic hybrid hollow particles composed of an epoxy resin and a reactive silane coupling agent.

Furthermore, Japanese Patent Application Publication No. 2017-61664 (PTL 4) discloses organic-inorganic hybrid hollow particles composed of a radically reactive monomer having an epoxy or oxetane group and, a radically reactive monomer having a silyl group.

### CITATION LIST

### Patent Literature

PTL 1: Japanese Patent Application Publication No. 2002-80503
PTL 2: Japanese Patent Application Publication No. 2005-215315
PTL 3: Japanese Patent Application Publication No. 2010-840_18
PTL 4: Japanese Patent Application Publication No. 2017-61664

### SUMMARY OF INVENTION

### Technical Problem

However, hollow particles disclosed in PTL 1 and 2 are likely to have pores (pinholes) penetrating from the shell surface to the hollow interior and, therefore, have a problem that the desired characteristics (light scattering properties, low refractive index, etc.) cannot be achieved when the hollow particles are used for light scattering materials, low reflection materials, or the like.

Furthermore, also in the organic-inorganic hybrid hollow particles disclosed in PTL 3 and 4, particles with collapsed shapes may occur when the hollow portions are enlarged, and thus has a problem that sufficient properties (light scattering properties, low refractive index, etc.) cannot be achieved when the hollow particles are used for light scattering materials, low reflection materials, or the like.

The present invention has been made in view of the above state of the art and has an object to provide hollow particles that can suppress the occurrence of pinholes in shells and prevent the collapse of hollow portions due to deformation, and the applications thereof.

### Solution to Problem

The inventor has made intensive studies to achieve the object mentioned above and, as a result, has succeeded in developing hollow particles, the average particle diameter and sphericity of which are adjusted to specific ranges, and found that the problem mentioned above can be overcome by using such hollow particles. The present invention has been completed through further studies.

That is, the present invention provides an invention of the following aspects.

### Item 1.

Hollow particles comprising a shell and a hollow portion surrounded by the shell,
wherein the shell contains a (meth)acrylic-based resin;
wherein the hollow particles have an average particle diameter of 10 nm to 150 nm;
wherein the hollow particles have a sphericity of 0.90 to 1.0; and
wherein the hollow particles have a hollow ratio of 35% to 70%.

### Item 2.

The hollow particles according to the item 1, wherein the hollow particles show a 3% thermal decomposition temperature of 245° C. or higher.

### Item 3.

The hollow particles according to the item 1 or 2, wherein the (meth)acrylic-based resin contains a polymer derived from a (meth)acrylic-based reactive monomer having an epoxy group and/or a polymer derived from a (meth)acrylic-based reactive monomer having an oxetane group

### Item 4.

The hollow particles according to any one of the items 1 to 3, wherein the (meth)acrylic-based resin contains a polymer derived from a heterocyclic amine compound.

### Item 5.

The hollow particle according to any one of the items 1 to 4, wherein the heterocyclic amine compound is at least one selected from the group consisting of piperazine, N-methylpiperazine, N, N-dimethylpiperazine, N-aminoethliiperazine, and imidazole.

### Item 6.

The hollow particles according to any one of the items 1 to 5, wherein the shell contains an inorganic component.

### Item 7.

A dispersion liquid including the hollow particles according to any one of the items 1 to 6.

### Item 8.

A coating agent including the hollow particles according to any one of the items 1 to 6.

### Item 9.

A heat-insulating film including the hollow particles according to any one of the items 1 to 6.

### Item 10.

An antireflection film and an antireflection film-attached substrate including the hollow particles according to any one of items 1 to 6.

### Item 11.

A light extraction film and a light extraction film-attached substrate including the hollow particles according to any one of items 1 to 6.

### Item 12.

A low dielectric constant film including the hollow particles according to any one of items 1 to 6.

### Advantageous Effects of Invention

The hollow particles of the present invention can suppress the occurrence of pinholes in shells and prevent the collapse of hollow portions due to deformation. The hollow particles of the present invention have such excellent characteristics and, therefore, can be suitably used for various applications such as a dispersion liquid, a coating agent, a heat-insulating film, an antireflection film, an antireflection film-attached substrate, a light extraction film, a light extraction film-attached substrate, and a low dielectric constant film.

### DESCRIPTION OF EMBODIMENTS

Hereinafter, suitable embodiments of the present invention will be described in detail.

In the present description, the term “comprise” and “contain” encompass the concepts of “comprise”, “contain”, “consisting essentially of”, and “consisting of”.

In the numerical ranges stated in stages in the present description, the upper limit value or the lower limit value of the numerical range in a certain stage may be combined arbitrarily with the upper limit value or the lower limit value in the numerical range of another stage. In addition, in a numerical range described in the present description, the upper limit value or the lower limit value of the numerical range may be replaced with a value indicated in the Examples or a value that can be uniquely derived from the Examples. Furthermore, in the present description, numerical values linked with the preposition “to” mean a numerical range including the values sandwiching the preposition “to” as the lower and upper limit values.

In the present description, “(meth)acrylic” means “acrylic” or “methacrylic”, and “(meth)acrylate” means “acrylate” or “methacrylate”.

In the present description, “A and/or B” means “either one of A and B” or “both A and B” and specifically means “A”, “B”, or “A and B”.

In the present description, a room temperature means a temperature in the range of 20° C. to 25° C.

<Hollow Particles>

The hollow particles of the present invention are provided with the following constitutions (i) to (v):
(i) the hollow particles have a shell and a hollow portion surrounded by the shell,
(ii) the shell contains a (meth)acrylic-based resin;
(iii) the hollow particles have an average particle diameter of 10 nm to 150 nm;
(iv) the hollow particles have a sphericity or 0.90 to 1.0; and
(v) the hollow particles have a hollow ratio of 35% to 70%.

The hollow particles of the present invention can suppress the occurrence of pinholes in shells and prevent the collapse of hollow portions due to deformation by having the constitutions (i) to (v) mentioned above. To “prevent the collapse of hollow portions due to deformation” means that the hollow particles maintain a spherical shape.

<Shell and Hollow Portion>

The hollow particles of the present invention have a shell that contains a (meth)acrylic-based resin and a hollow portion surrounded by the shell. The present invention pertains to hollow particles with a structure in which a hollow portion is surrounded by a shell containing a (meth)acrylic-based resin. The hollow particles of the present invention are characterized in that the interior of the particle has a hollow structure.

In the present invention, the shell contains a (meth)acrylic-based resin. It is preferred that the hollow particles of the present invention have a shell composed of at least one layer, and the at least one layer contains a (meth)acrylic-based resin. It is more preferred that the hollow particles of the present invention have a shell composed of at least one layer, and the at least one layer is constituted of a (meth)acrylic-based resin. The layer constituting the shell may be constituted of one layer, or two or more multiple layers (for example, two layers, three layers, or four layers, and the like). In the present invention, the entire shell is most preferably constituted of a (meth)acrylic-based resin.

<Average Particle Diameter>

The hollow particles of the present invention have an average particle diameter of 10 nm to 150 nm. The average particle diameter of the hollow particles of the present invention may be 10 nm, 20 nm, 30 nm, 40 nm, 50 nm, 60 nm, 70 nm, 80 nm, 90 no, 100 nm, 110 nm, 120 nm, 130 nm, 140 nm, or 150 nm. In the present invention, the average particle diameter of the hollow particles is more preferably 30 nm to 120 nm. When the average particle diameter is less than 10 nm, agglomeration of hollow particles may occur, and handleability may be poor. When the average particle diameter exceeds 150 nm, the surface unevenness and the scattering on the particle interface may be large when the hollow particles are kneaded with coating agents, resins, or the like, and whitening may occur.

<Sphericity>

The hollow particles of the present invention have a sphericity of 0.90 or more and 1.0 or less. In the present description, sphericity means a ratio of the shortest diameter to the longest diameter of a hollow particle (shortest diameter/longest diameter). When the sphericity is less than 0.90, the hollow particles are easily collapsed when the hollow particles are kneaded with coating agents, resins, or the like, and thus, the desired characteristics (light scattering properties, low refractive index, etc.) may not be achieved. When the sphericity exceeds 1.0, the hollow particles are easily collapsed when the hollow particles are kneaded with coating agents, resins, or the like, and thus, the desired characteristics (light scattering properties, low refractive index, etc.) may not be achieved. In the present invention, the sphericity of the hollow particles may be a value of 0.915, 0.92, 0.925, 0.93, 0.935, 0.94, 0.945, 0.95, 0.955, 0.96, 0.965, 0.97, 0.975, 0.98, 0.985, 0.99, and 0.995. In the present invention, the lower limit of the sphericity of the hollow particles is preferably more than 0.91 (over 0.91), more preferably 0.92 or more, and still more preferably 0.93 or more. The upper limit of the sphericity of the hollow particles is not particularly limited but may be 0.999 or less industrially.

<Hollow Ratio>

The hollow particles of the present invention have a hollow ratio of 35% to 70%. The hollow Particles of the present invention preferably have a hollow ratio of 37% to 65%, more preferably have a hollow ratio of 39% to 63%, and further preferably have a hollow ratio of 41% to 60%. In the present description, a hollow ratio means a proportion of a volume of hollow portions in relation to the volume of a hollow particle and may be determined by a measurement method explained in the Examples described later. When the hollow ratio is in the range of 35% to 70%, hollow particles with high shell strength can be produced, and therefore, the desired characteristics (light scattering properties, low refractive index, etc.) can be achieved when the hollow particles are used for optical scattering materials, low reflection materials, and the like.

<3% Thermal Decomposition Temperature>

In the present description, a 3% thermal decomposition temperature means a temperature (° C.) at which the mass reduction rate of the hollow particles reaches 3 by mass when the hollow particles are heated at a temperature rising rate of 10° C./min in an air atmosphere. A 3% thermal decomposition temperature specifically means a temperature (° C.) at which the mass reduction rate of the hollow particles reaches 3% by mass when the hollow particles are heated from 40° C. to 800° C. at a temperature rising rate or 10° C./min in an air atmosphere using a simultaneous thermogravimetry/differential thermal analyzer (TG/DTA). The specific measuring method of a 3% thermal decomposition temperature is explained in the Examples described below.

in the present invention, the 3% thermal decomposition temperature of the hollow particles is preferably 245° C. or higher, more preferably 248° C. or higher, still more preferably 250° C. or higher, further preferably 252° C. or higher, and particularly preferably 255° C. or higher in view of heat resistance improvement. In the present invention, the upper limit of the 3% thermal decomposition temperature of the hollow particles is normally 600° C. or lower, preferably 550° C. or lower, more preferably 500C or lower, and still more preferably 450° C. or lower.

<Coefficient of Variation>

The coefficient or variation (the CV value), which is an index for evaluating monodispersity, of the hollow particles of the present invention is preferably 30% or less, more preferably 25% or less, and still more preferably 20% or less. When the CV value is 30% or less, coarse hollow particles become fewer, which improves dispersibility in the binder. The CV value may be 30%, 25%, 20%, 15%, 10%, 5%, 3%, and 1%. The lower limit of the CV value is preferably 0%.

<Refractive Index>

The refractive index of the shell of the hollow particles of the present invention is preferably 1.57 or less, more preferably 1.56 or less, and still more preferably 1.55 or less. When the refractive index of the shell is 1.57 or less, an excellent low refractive index can be achieved when the hollow particles are used in low refractive index materials. When the hollow particles are used in low refractive index materials, the lower limit does not exist because the lower the refractive index of the shell, the better.

<(Meth)acrylic-based Resin>

The shell of the hollow particles of the present invention contains a (meth)acrylic-based resin. The shell may contain a resin other than (meth)acrylic-based resins in the range that does not impair the effects of the present invention.

The (meth)acrylic-based resin is a polymer obtained through the reaction of a (meth)acrylic-based reactive monomer. The (meth)acrylic-based resin is preferably a polymer having a crosslinked structure (also referred to as “a crosslinked polymer”) produced by adding and reacting a cross-linkable monomer to a polymer obtained through a reaction of a (meth)acrylic-based reactive monomer.

The (meth)acrylic-based resin preferably contains a polymer derived from a (meth)acrylic-based reactive monomer having an epoxy group and/or a polymer derived from a (meth)acrylic-based reactive monomer having an oxetane group. In other words, the (meth)acrylic-based resin preferably contains a polymer including a constitutional unit derived from a (meth)acrylic-based reactive monomer having an epoxy group and/or a polymer including a constitutional unit derived from a (meth)acrylic-based reactive monomer having an oxetane group. The (meth)acrylic-based resin more preferably contains a polymer derived from a (meth)acrylic-based reactive monomer having an epoxy group. In other words, the (meth)acrylic-based resin more preferably contains a polymer including a constitutional unit derived from a (meth)acrylic-based reactive monomer having an epoxy group. An epoxy group or an oxetane group is a functional group that produces a polymer by a reaction with a compound having an amino group, a carboxy group, a chlorosulfonyl group, a mercapto group, a hydroxy group, an isocyanato group, or the like. A (meth)acrylic-based reactive monomer having an epoxy group or an oxetane group allows a polymer having a crosslinked structure (a crosslinked polymer) to be produced by radical polymerization of a (meth)acrylic-based reactive monomer having an epoxy group or an oxetane group and a subsequent reaction of an epoxy group or an oxetane group with a crosslinking monomer.

The shell constituting the hollow particles of the present invention preferably contains an inorganic component. It is preferable that the (meth)acrylic-based resin further contains a polymer derived from a (meth)acrylic-based reactive monomer having a sill group. In other words, it is preferable that the (meth)acrylic-based resin further contains a polymer including a constitutional unit derived from a (meth)acrylic-based reactive monomer having a silyl group. A (meth)acrylic-based reactive monomer having a silyl group allows a polymer having a crosslinked structure (a crosslinked polymer) to be produced by radical polymerization of (meth)acrylic-based reactive monomer having a silyl group and a subsequent reaction of a silyl group with a crosslinking monomer.

In the present invention, it is preferred that the (meth)acrylic-based resin contains a polymer that includes, as a constitutional component, a copolymer composed of a (meth)acrylic-based reactive monomer having an epoxy group or an oxetane group and a (meth)acrylic-based reactive monomer having a silyl group. In this copolymer, a ratio (mass ratio) between the (meth)acrylic-based reactive monomer units having an epoxy group or an oxetane group and the (meth)acrylic-based reactive monomer units having a silyl group is preferably the former: the latter=1:100 to 1:0.001. Within this percentage range, hollow particles with high shell strength can be obtained, and therefore, the desired characteristics (light scattering properties, low refractive index, etc.) can be achieved when the hollow particles are used for optical scattering materials, low reflection materials, or the like. In the copolymer, a more preferred ratio (mass ratio) between the (meth)acrylic-based reactive monomer units having an epoxy group or an oxetane group and the (meth)acrylic-based reactive monomer units having a silyl group is in the range of the former: the latter=1:10 to 1:0.001, and still more preferred ratio (mass ratio) is in the range of the former: the latter=1:1 to 1:0.01.

In the (meth)acrylic-based resin, the total of the content proportions of the (meth)acrylic-based reactive monomer having an epoxy group or an oxetane group and the (meth)acrylic-based reactive monomer having a silyl group is preferably 10% by mass or more of all components derived from (meth)acrylic-based reactive monomers. The content may be 10% by mass, 20% by mass, 30% by mass, 40% by mass, 50% by mass, 60% by mass, or 70% by mass. In the (meth)acrylic-based resin, the total of the content proportions of the (meth)acrylic-based reactive monomer having an epoxy group or an oxetane group and the (meth)acrylic-based reactive monomer having a silyl group is more preferably 30% by mass or more, still more preferably 50% by mass or more, of all components derived from (meth)acrylic-based reactive monomers.

The content of the (meth)acrylic-based reactive monomer having an epoxy group or an oxetane group is preferably 50 parts by mass to 90 parts by mass in relation to 100 parts by mass of the total of the (meth)acrylic-based reactive monomer having an epoxy group or an oxetane group and the (meth)acrylic-based reactive monomer having a silyl group, more preferably 55 to 88 parts by mass, and more preferably 60 to 85 parts by mass. The content of the (meth)acrylic-based reactive monomer having an epoxy group is preferably 50 parts by mass to 90 parts by mass, more preferably 55 to 88 parts by mass, and more preferably 60 to 85 parts by mass in relation to 100 parts by mass of the total of the (meth)acrylic-based reactive monomer having an epoxy group and the (meth)acrylic-based reactive monomer having a silyl group.

The (meth)acrylic-based resin preferably contains a polymer derived from a crosslinking monomer having a nitrogen atom (a polymer including a constitutional unit derived from a crosslinking monomer having a nitrogen atom), more preferably contains a polymer derived from an amine compound (a polymer including a constitutional unit derived from an amine compound), and still more preferably contains a polymer derived from a heterocyclic amine compound (a polymer including a constitutional unit derived from a heterocyclic amine compound). The (meth)acrylic-based resin is converted into a crosslinked polymer having a nitrogen atom by further crosslinking a polymer obtained by polymerizing the (meth)acrylic-based reactive monomer with a crosslinking monomer having a nitrogen atom.

When the (meth)acrylic-based resin contains a polymer derived from an amine compound, the blending amount of the amine compound is normally 1 part by mass to 45 parts by mass, preferably 5 to 42 parts by mass, more preferably 10 to 38 parts by mass, still more preferably 15 to 35 parts by mass, further preferably 20 to 32 parts by mass, and particularly preferably 22 to 30 parts by mass in relation to 100 parts by mass of the total of the (meth)acrylic-based reactive monomers in view of enhancing the heat resistance and mechanical strength of the hollow particles.

When the (meth)acrylic-based resin contains a polymer derived from an amine compound, the blending amount of the amine compound is normally 1 part by mass to 45 parts by mass, preferably 5 to 42 parts by mass, more preferably 10 to 38 parts by mass, still more preferably 15 to 35 parts by mass, further preferably 20 to 32 parts by mass, and particularly preferably 22 to 30 parts by mass in relation to 100 parts by mass or the total of the (meth)acrylic-based reactive monomer having an epoxy group and the (meth)acrylic-based reactive monomer having a silyl group in view of enhancing the heat resistance and mechanical strength of the hollow particles.

When the (meth)acrylic-based resin contains a polymer derived from a heterocyclic amine compound, the blending amount of the heterocyclic amine compound is normally 1 part by mass to 45 parts by mass, preferably 5 to 42 parts by mass, more preferably 10 to 38 parts by mass, still more preferably 15 to 35 parts by mass, further preferably 20 to 32 parts by mass, and particularly preferably 22 to 30 parts by mass in relation to 100 parts by mass of the total of the (meth)acrylic-based reactive monomers in view of enhancing the heat resistance and mechanical strength of the hollow particles.

When the (meth)acrylic-based resin contains a polymer derived from a heterocyclic amine compound, the blending amount of the heterocyclic amine compound is normally 1 part by mass to 45 parts by mass, preferably 5 to 42 parts by mass, more preferably 10 to 38 parts by mass, still more preferably 15 to 35 parts by mass, further preferably 20 to 32 parts by mass, and particularly preferably 22 to 30 parts by mass in relation to 100 parts by mass of the total of the (meth)acrylic-based reactive monomer having an epoxy group and the (meth)acrylic-based reactive monomer having a silyl group in view of enhancing the heat resistance and mechanical strength of the hollow particles.

It should be noted that specific examples of the “heterocyclic amine compound” described in this paragraph include heterocyclic amine compounds explained in the item of the <Heterocyclic Amine Compound> described below.

The (meth)acrylic-based resin is preferably an organic-inorganic hybrid resin containing a silicon component (a Si-containing resin). In the present description, the term “organic-inorganic” means that silicon is included as an inorganic component, and a component other than silicon is included as an organic component.

The content of the (meth)acrylic-based resin in the shell of the hollow particles is preferably 5 to 100 parts by mass, more preferably 10 to 100 parts by mass, still more preferably 50 to 100 parts by mass, further preferably 75 to 100 parts by mass, particularly preferably 90 to 100 parts by mass, and most preferably 99 to 100 parts by mass in relation to 100 parts by mass of the shell of the hollow particles. The content of the (meth)acrylic-based resin of 5 parts by mass or more in relation to 100 parts by mass of the shell of the hollow particles allows the dispersibility in the organic binder used to prepare a heat-insulating painting material to be improved and whitening of the coated film to be prevented.

<(Meth) acrylic-based Reactive Monomer>

A (meth)acrylic-based reactive monomer has a (meth)acrylic-based reactive functional group. Examples of the (meth)acrylic-based reactive monomer include esters of (meth)acrylic acid and an alcohol with 1 to 25 carbon atoms and the like.

Examples of esters of (meth)acrylic acid and an alcohol with 1 to 25 carbon atoms include methyl (meth)acrylate, ethyl (meth)acrylate, propyl (meth)acrylate, n-butyl (meth)acrylate, isobutyl (meth)acrylate, tert-butyl (meth)acrylate, pentyl (meth)acrylate, (cyclo) hexyl (meth)acrylate, heptyl (meth)acrylate, (iso) octyl (meth)acrylate, nonyl (meth)acrylate, (iso) decyl (meth)acrylate, norbornenyl (meth)acrylate, isobornyl (meth)acrylate, adamantyl (meth)acrylate, lauryl (meth)acrylate, tetradecyl (meth)acrylate, (iso) stearyl (meth)acrylate, isobornyl (meth)acrylate, phenoxyethylene glycol (meth)acrylate, phenoxydiethylene glycol (meth)acrylate, 2-ethylhexyl (meth)acrylate, and the like. These esters may be used alone or in combination of two or more of these.

The (meth)acrylic-based reactive monomer is preferably a reactive monomer having a (meth)acrylic-based reactive functional group and a non-(meth)acrylic-based reactive functional group. Polymer particles can be produced by polymerizing a reactive monomer with a (meth)acrylic-based reactive functional group and a non-(meth)acrylic-based reactive functional group based on either of two functional groups. A reaction of the other functional group remaining in these polymer particles with a crosslinkinq monomer converts these polymer particles into a polymer having a crosslinked structure (a crosslinked polymer).

Before crosslinking as described above, a non-reactive solvent is included in polymer particles by mixing the solvent with a reactive monomer in advance or by allowing the solvent to be absorbed into polymer particles after the polymer particles are prepared, and then performing the crosslinking reaction described above to cause phase separation between the polymer and the non-reactive solvent, whereby microcapsule particles that encapsulate the non-reactive solvent are obtained. The hollow particles are then obtained by removing the non-reactive solvent.

The (meth)acrylic-based reactive monomer is preferably a (meth)acrylic-based reactive monomer having an epoxy group or an oxetane group. Examples of (meth)acrylic-based reactive monomers having an epoxy group or an oxetane group include glycidyl (meth)acrylate, 4-hydroxybutyl (meth)acrylate glycidyl ether, (3-ethyloxetan-3-yl)methyl (meth)acrylate, 3,4-epoxycyclohexylmethyl (meth)acrylate, and the like. These monomers may be used alone or in combination of two or more of these. It should be noted that glycidyl (meth)acrylate (methacrylic acid glycidyl ester) means glycidyl methacrylate and glycidyl acrylate (acrylic acid glycidyl ester).

The (meth)acrylic-based reactive monomer is preferably a (meth)acrylic-based reactive monomer having a silyl group. Examples of the (meth)acrylic-based reactive monomer having a silyl group include 3-methacryloypropyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, and the like. These monomers may be used alone or in combination of two or more of these.

<Crosslinking Monomer>

The crosslinking monomer is preferably a crosslinking monomer containing a nitrogen atom. As the crosslinking monomer containing a nitrogen atom, amine compounds are preferred.

Examples of the amine compound include an aliphatic amine compound and a heterocyclic amine compound. In the present invention, it is preferred not to use an aliphatic amine compound alone and not to use a combination of two or more kinds of aliphatic amine compounds as amine compounds. In the present invention, it is preferred to use an aliphatic amine compound and a heterocyclic amine compound in combination or to use a heterocyclic amine compound alone. In the present invention, it is preferred to use a heterocyclic amine compound alone as an amine compound. In the present invention, it is preferred not to use a cyclo ring-containing amine compound alone and not to use a combination of two or more kinds of cyclo ring-containing amine compounds as amine compounds. In the present invention, a cyclo ring-containing amine compound and a heterocyclic amine compound may be used in combination. In the present invention, it is preferred not to use an amine compound having a polyoxyalkylene structure in the molecular structure alone and not to use a combination of two or more kinds of amine compounds having a polyoxyalkylene structure in the molecular structure as amine compounds. In the present invention, it is preferred not to use an aromatic ring-containing amine compound alone and not to use a combination of two or more kinds of aromatic ring-containing amine compounds as amine compounds. In the present invention, an aromatic ring-containing amine compound and a heterocyclic amine compound may be used in combination.

<Aliphatic Amine Compound>

Examples of the aliphatic amine compound include ethylenediamine, N, N, N′, N′-tetramethylethylenediamine, propylenediamine, N, N,N, N′-tetramethylpropylenediamine, dimethylaminopropylamine, diethylaminopropylamine, dibutylaminopropylamine, diethylene triamine, N, N, N′, N″, N″-pentamethyldiethylenetriamine, triethylenetetramine, tetraethylenepentamine, 3,3′-diaminodipropylamine, butanediamine, pentanediamine, hexanediamine, trimethylhexanediamine, N,N,N′,N-tetramethylhexanediamine bis (2-dimethylaminoethyl) ether, dimethylaminoethoxyethoxyethanol, triethanolamine, dimethylaminobexanol, 3, 9-bis (3-aminopropyl)-2, 4, 8, 10-tetraoxyspiro [5,5] undecane adduct, and the like. It is preferred not to use these aliphatic amine compounds alone and not to use a combination of two or more kinds of these as amine compounds.

In the present invention, it is more preferred not to use ethylenediamine, diethylenetriamine, and tetraethylenepentamine as aliphatic amine compounds. In the present invention, it is preferred not to use an aliphatic amine compound alone and not to use a combination of two or more kinds of aliphatic amine compounds. Meanwhile, it is preferred to use an aliphatic amine compound and a heterocyclic amine compound in combination. When an aliphatic amine compound and a heterocyclic amine compound are used in combination in the present invention, it is preferred to use propylene diamine as the aliphatic amine compound. In this case, it is preferred to use a heterocyclic amine compound explained in the item of <Heterocyclic Amine Compound> described below as the heterocyclic amine compound.

<Cyclo Ring-Containing Amine Compound>

Examples of the cyclo ring-containing amine compound include N, N-dimethylcyclohexylamine, 1, 3-bis (aminomethyl)cyclohexane, p-menthane-1, 8-diamine, isophoronediamine, 4, 4′-diaminodicyclohexylmethane, and the like. It is preferred not to use this cyclo ring-containing amine compound alone and not to use a combination of two or more kinds of these cyclo ring-containing amine compounds as amine compounds. 1n the present invention, it is preferred not to use 1, 3-bis (aminomethyl) cyclohexane as the cyclo ring-containing amine compound.

<Heterocyclic Amine Compound>

Examples of the heterocyclic amine compound include pyrrolidine, piperidine, piperazine, N-methylpiperazine, N,N-dimethylpiperazine, N-aminoethylpiperazine, N, N′,N′-trimethylamisnoethylpiperazine, morpholine, methylimorpholine, ethylmorpholine, quinuclidine (1-azabicyclo[2.2.2]octane), triethylenediamine (1, 4-diazabicyclo [2.2.2] octane), pyrrole, pyrazole, pyridine, hexaydro-, 3, 5-tris(3-dimethylaminopropyl)-1,3,5-triazine, 1, 8-diazabicyclo-[5.4.0]-7-undecene, imidazole, 1-methylimidazole, 2-methylimidazole, 3-methylimidazole, 4-methylimidazol, 5-methylimidazole, 1-ethylimidazole, 2-ethylimidazol, 3-ethylimidazole, 4-ethylimidazole, 5-ethylimidazol, 1-n-propylimidazole, 2-n-propylimidazole, 1-isopropylimidazole, 2-isopropylimidazole, 1-n-butylimidazole, 2-n-butylimidazole, 1-isobutylimidazole 2-isobutylimidazole, 2-undecyl-1H-imidazole, 2-heptadecyl-1H-imidazole, 1,2-dimethylimidazole, 1, 3-dimethylimidazole, 2,4-j dimethylimidazole, 2-ethyl-4-methylimidazole, -phenylimidazole, 2-phenyl-1H-imidazole, 4-methyl-2-phenyl-1H-imidazo, 2-phenyl-4-methylimidazole, 1-benzyl-2-methylimidazole, 1-benzyl-2-phenylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 2-phenylimidazole-isocyanuric acid adducts, 2-methylimidazole-isocyanuric acid adducts, 2-phenyl-4,5-dihydroxymethylimidazole, 2-phenyl-methyl-hydroxymethylimidazole, 1-cyanoethyl-2-phenyl-4, 5-di (2-cyanoethoxy)methylimidazole, 1-dodecyl-2-methyl-3-benzimidazolium chloride, -benzyl-2-phenylimidazole hydrochloride, and the like. These heterocyclic amine compounds may be used alone or in combination of two or more of these. Among these heterocyclic amine compounds, at least one selected from the group consisting of piperazine, N-methylpiperazine, N, N′-dimethylpiperazine, N-aminoethylpiperazine, and imidazole is preferred, and at least one selected from the group consisting of piperazine, N-methylpiperazine, and N-aminoethylpiperazine is more preferred.

<Amine Compound having Polyoxyalkylene Structure in Molecular Structure>

Examples of amine compounds having a polyoxyalkylene structure in the molecular structure include polyoxyethylenediamine, polyoxypropylenediamine, and the like. It is preferred not to use this amine compound having a polyoxyalkylene structure in the molecular structure alone and not to use a combination of two or more kinds of these amine compounds having a polyoxyalkylene structure in the molecular structure.

<Aromatic Ring-Containing Amine Compound>

Examples of aromatic ring-containing amine compounds include phenylenediamine, diaminodiphenylmethane, diaminodiphenylsulfone, N-methylbenzylamine, N,N-dimethylbenzylamine, diethyltoluenediamine, m-xylylenediamine, α-methylbenzylmethlylamine, 2, 4, 6-tris (dimethylaminomethyl)phenol, and the like. It is preferred not to use this aromatic ring-containing amine compound alone and not to use a combination of two or more kinds of these aromatic ring-containing amine compounds. In the present invention, it is more preferred not to use m-xylylenediamine as the aromatic ring-containing amine compound.

In the present invention, it is preferred to use the aliphatic amine compound and the heterocyclic amine compound in combination as the amine compounds from the viewpoint of enhancing the heat resistance and mechanical strength of the hollow particles. In the present invention, it is preferred to use the heterocyclic amine compound alone a the amine compound from the viewpoint of further enhancing the heat resistance and mechanical strength of the hollow particles.

In a preferred embodiment of the present invention, it is preferred that the (meth)acrylic-based resin contains at least one polymer selected from the group consisting of:
(i) a polymer derived from an aliphatic amine compound and a heterocyclic amine compound;
(ii) a polymer derived from a cyclo ring-containing amine compound and a heterocyclic amine compound;
(iii) a polymer derived from an aromatic ring-containing amine compound and a heterocyclic amine compound; and
(iv) a polymer derived only from a heterocyclic amine compound.

In other words, in a preferred embodiment of the present invention, it is preferred that the (meth)acrylic-based resin contains at least one polymer selected from the group consisting of
(i) a polymer including a constitutional unit derived from an aliphatic amine compound and a heterocyclic amine compound;
(ii) a polymer including a constitutional unit derived from a cyclo ring-containing amine compound and a heterocyclic amine compound;
(ii) a polymer including a constitutional unit derived from an aromatic ring-containing amine compound and, a heterocyclic amine compound; and
(iv) a polymer including a constitutional unit derived only from a heterocyclic amine compound.

In the preferred embodiment of the present invention, it is more preferred that the (meth)acrylic-based resin further contains a polymer derived from a (meth)acrylic-based reactive monomer having an epoxy group [a polymer including a constitutional unit derived from a (meth)acrylic-based reactive monomer having an epoxy group] and/or a polymer derived from a (meth)acrylic-based reactive monomer having an oxetane group [a polymer including a constitutional unit derived from a (meth)acrylic-based reactive monomer having an oxetane group].

In the preferred embodiment of the present invention, it is more preferred to exclude ethylenediamine, diethylenetriamine, and tetraethylenepentamine as aliphatic amine compounds.

In the preferred embodiment of the present invention, it is preferred to exclude 1, 3-bis (aminomethyl) cyclohexane a a cyclo ring-containing amine compound.

In the preferred embodiment of the present invention, it is preferred to exclude m-xylylenediamine as the aromatic ring-containing amine compound.

In the preferred embodiment of the present invention, the heterocyclic amine compound is more preferably at least one selected from the group consisting of piperazine, N-methylpiperazine, N, N′-dimethylpiperazine, N-aminoethylpiperazine, and imidazole, and still more preferably at least one selected from the group consisting of piperazine, N-methylpiperazine, and N-aminoethylpiperazine.

In a more preferred embodiment of the present invention, it is preferred that the (meth)acrylic-based resin contains polymers derived from an aliphatic amine compound and a heterocyclic amine compound and/or a polymer derived only from a heterocyclic amine compound. In other words, in a preferred embodiment of the present invention, it is more preferred that a (meth)acrylic-based resin contains a polymer including a constitutional unit derived from an aliphatic amine compound and a heterocyclic amine compound and/or a polymer including a constitutional unit derived only from a heterocyclic amine compound.

In the preferred embodiment of the present invention, it is still more preferred that the (meth)acrylic-based resin further contains a polymer derived from a (meth)acrylic-based reactive monomer having an epoxy group [a polymer including a constitutional unit derived from a (meth)acrylic-based reactive monomer having an epoxy group] and/or a polymer derived from a (meth)acrylic-based reactive monomer having an oxetane group [a polymer including a constitutional unit derived from a (meth)acrylic-based reactive monomer having an oxetane group].

In the preferred embodiment of the present invention, it is still more preferred to exclude ethylenediamine, diethylenetriamine, and tetraethylenepentamine as aliphatic amine compounds.

In the preferred embodiment of the present invention, it is preferred to exclude 1,3-bis (aminomethyl) cyclohexane as the cyclo ring-containing amine compound.

In the preferred embodiment of the present invention, it is still more preferred to exclude m-xylylenediamine as an aromatic ring-containing amine compound.

In the preferred embodiment of the present invention, the heterocyclic amine compound is still more preferably at least one selected from the group consisting of piperazine, N-methylpiperazine, N, N′-dimethylpiperazine, N-aminoethylpiperazine, and imidazole and particularly preferably at least one selected from the group consisting of piperazine, N-methylpiperazine, and N-aminoethylpiperazine.

<Surface Treating Agent>

The hollow particles of the present invention may have a surface treated with a compound having at least one anionic group. The surface treated with this compound imparts, to the hollow particles, properties such as heat resistance, dispersibility in an organic solvent, and resistance to penetration of low molecular weight binder components into the hollow interior.

Compounds having an anionic group can be selected from hydrochloric acid, organic dianhydrides, oxoacids (for example, inorganic acids such as nitric acid, phosphoric acid, sulfuric acid, and carbonic acid; and organic acids such as carboxylic acid compounds, alkyl ester compounds of sulfuric acid, sulfonic acid compounds, phosphoric acid ester compounds, phosphonic acid compounds, and phosphinic acid compounds may be mentioned). As a compound having an anionic group, a compound containing a phosphorus atom and/or a sulfur atom as constitutional components.

A carboxylic acid compound is not particularly limited as long as it is a compound containing a carboxy group. For example, linear carboxylic acids such as formic acid, acetic acid, propionic acid, butyric acid, valeric acid, hexanoic acid, heptannoic acid, octanoic acid, nonanoic acid, decanoic acid, dodecanoic acid, tetradecanoic acid, and stearic acid; branched carboxylic acid such as pivalic acid, 2, 2-dimethylbutyric acid, 3,3-dimethylbutyric acid, 2,2-dimethylvaleric acid, 2, 2-dimethylbutyric acid, 3,3-dimethylbutyric acid, 2-ethylhexanoic acid, 2-methylheptanoic acid, 4-methyloctanoic acid, and neodecanoic acid; and cyclic carboxylic acids such as naphthenic acid and cyclohexanedicarboxylic acid, and the like may be mentioned. Among these, linear carboxylic acids with 4 to 20 carbon atoms and branched carboxylic acids with 4 to 20 carbon atoms, and the like are preferred in order to increase the dispersibility in an organic solvent efficiently.

As a carboxylic acid compound, carboxylic acids having a radically reactive functional group such as a vinyl group, a (meth)acryloyl group, an allyl group, a maleoyl group, a fumaroyl group, a styryl group, and a cinnamoyl group can also be used. For example, acrylic acid, methacrylic acid, 2-acryloyloxyethyl succinate, 2-methacryloyloxyethyl succinate, 2-acryloyloxyethyl hexahydrophthalate, 2-methacryloyloxyethyl hexahydrophthalate, 2-acryloyloxyethyl phthalate, 2-methacryloyloxyethyl phthalate, vinyl benzoate, and the like may be mentioned.

Examples of alkyl ester compounds of sulfuric acid include dodecyl sulfate and the like.

A sulfonic acid compound is not particularly limited as long as it is a compound containing a sulfo group. For example, p-toluenesulfonic acid, benzenesulfonic acid, dodecylbenzenesulfonic acid, methylsulfonic acid, ethylsulfonic acid, vinylsulfonic acid, allylsulfonic acid, methallylsulfonic acid, 2-acrylamido-2-methylpropanesulfonic acid, and the like may be mentioned.

A phosphoric acid ester compound is not particularly limited as long as it is an ester compound of phosphoric acid. For example, dodecyl phosphate and polyoxyethylene alkyl ether phosphate represented by the general formula (a) may be mentioned.

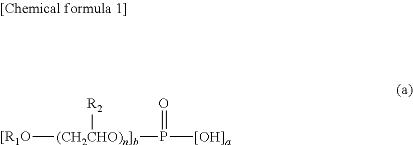

In the formula (a), R₁ is an alkyl group with 4 to 19 carbon atoms, an allyl group (CH₂═CHCH₂—), a (meth)acrylic group, or a styryl group. As alkyl groups with 4 to 19 carbon atoms, a butyl group, a pentyl group, an octyl group, a nonyl group, a decyl group, an undecyl group, a dodecyl group, a tridecyl group, and a stearyl group may be mentioned. These alkyl groups may be linear or branched.

R₂ is H or CH₃.

n is the number of moles of alkylene oxides added and is a numerical value in the range necessary for providing the number of moles added of 0 to 30 when the whole is assumed to be 1 mole.

The combination of a and b is a combination of 1 and 2 or 2 and 1.

As a phosphoric acid ester compound, known commercial products can be widely used. Ass a commercial product, “KAYAMER PM-21”, available from Nippon Kayaku Co., Ltd., may be used, for example.

As oxo acids, polymers having acid groups may also be used. For example, DISPERBYK 103, DISPERBYK 110, DISPERBYK 118, DISPERBYK 111, DISPERBYK 190, DISPERBYK 19N, DISPERBYK 2015 (manufactured by BYK-Chemie GmbH), Solsperse 3000, Solsperse 21000, Solsperse 26000, Solsperse 36000, Solsperse 36600, Solsperse 41000, Solsperse 41090, Solsperse 43000, Solsperse 44000, Solsperse 46000, Solsperse 47000, Solsperse 53095, Solsperse 55000 (manufactured by Lubrizol Corporation), EFKA 4401, EFKA 4550 (manufactured by EFKA Additives B.V.), FLOWLEN G-600, FLOWLEN G-700, FLOWLEN G-900, FLOWLEN GW-1500, FLOWLEN GW-1640 (manufactured by Kyoeisha Chemical Co., Ltd.), Disperon 1210, Disperon 1220, Disperon 2100, Disperon 2150, Disperon 2200, Disperon DA-325, Disperon DA-375 (manufactured by Kusumoto Chemicals, Ltd.), Ajispur PB821, Ajispur PB822, Ajispur PB824, Ajispur PB881, Ajspur PN411, Ajispur PN411 (manufactured by Ajinomoto Fine-Techno Co., Inc.), and the like, although oxo acids are not limited to these.

The hollow particles of the present invention may be surface-treated with a silane-based coupling agent, a titanate-based coupling agent, an aluminate-based coupling agent, a zirconate-based coupling agent, an isocyanate-based compound, or the like according to need.

Examples of the silane-based coupling agent include alkoxy silanes such as methyltrimethoxysilane, dimethyldimethoxysilane, phenyltrimethoxysilane, methyltriethoxysilane, dimethyldiethoxysilane, phenyltriethoxysilane, n-propyltrimethoxysilane, n-propyltriethoxysilane, hexyltrimethoxysilane, hexyltriethoxysilane, octyltriethoxysilane, decyltrimethoxysilane, 1, 6-bis (trimethoxysilyl)hexane, and trifluoropropyltrimethoxysilane; silazanes such as hexamethyldisilazane; chlorosilanes such as chlorotrimethylsilane; vinyltrimethoxysilane, vinyltriethoxysilane, 2-(3, 4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, p-styryltrimethoxysilane, N-2-(aminoethyl)-3-aminopropylmethyldimethoxysilane, N-2-(aminoethyl)-33-aaminopropyltrimethoxysilane, 3-aminopropyltrimethoxysilane, 3-aminopropyltriethoxysilane, 3-triethoxysilyl-N-(1, 3-dimethyl-butylidene) propylamine, N-phenyl-3-aminopropyltrimethoxysilane, tris (trimethoxysilylpropyl) isocyanurate, 3-ureidopropyltrialkoxysilane, 3-mercaptopropylmethyldimethoxysilane, 3-mercaptopropyl trimethoxysilane, bis (triethoxysilylpropyl) tetrasulfide, 3-isocyanatopropyltriethoxysilane, and the like.

Other than the silane-based coupling agents mentioned above, a silane-based coupling agent represented by the following general formula (I) may be mentioned.

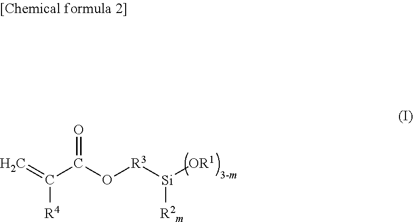

In the formula (I), R¹ each independently represents a substituted or unsubstituted alkyl group with 1 to 6 carbon atoms, an alkoxyalkyl group with 2 to 4 carbon atoms, or a phenyl group.

R² each independently represents a substituted or unsubstituted alkyl group with 1 to 6 carbon atoms, an alkoxyalkyl group with 2 to 4 carbon atoms, or a phenyl group.

R³ represents a divalent organic group with 1 to 30 carbon atoms.

R⁴ is a hydrogen atom or a methyl group.

m represents an integer of 0 to 2.

In R¹ and R², as the alkyl group with 1 to 6 carbon atoms, methyl, ethyl, propyl, butyl, pentyl, and hexyl may be mentioned. If possible, these alkyl groups can include structural isomers.

In R¹ and R², as the alkoxyalkyl group with 2 to 4 carbon atoms, methoxymethyl, methoxyethyl, ethoxymethyl, methoxybutyl, ethoxyethyl, and butoxymethyl may be mentioned. If possible, these alkoxyalkyl groups include structural isomers. As substituents of R¹ and R², halogen atoms (a fluorine atom, a chlorine atom, a bromine atom, and an iodine atom), a hydroxy group, an amino group, a phenyl group, and the like may be mentioned.

In R³, as the divalent organic group with 1 to 30 carbon atoms, alkanediyl groups such as methylene, ethylene, trimethylene, tetramethylene, pentamethylene, hexamethylene, heptamethylene, octamethylene, nonamethylene, decamethylene, undecamethylene, dodecamethylene, tridecamethylene, and tetradecamethylene. An alkanediyl group may have a branched structure substituted with an alkyl group.

Specific examples of the silane-based coupling agents represented by the general formula (I) mentioned above are listed below.
3-(meth)acryloxypropyltrimethoxysilane,
3-(meth)acryloxypropyltriethoxysilane,
3-(meth)acryloxypropylmethyldimethoxysilane,
3-(meth)acryloxypropylmethyldiethoxysilane,
4-(meth)acryloxybutyltriethoxysilane,
4-(meth)acryloxybutyltrimethoxysilane,
4-(meth)acryloxybutylmethyldimethoxysilane,
4-(meth)acryloxybutylmethyldiethoxysilane,
5-(meth)acryloxypentyltrimethoxysilane,
5-(meth)acryloxypentyltriethoxysilane,
5-(meth)acryloxypentylmethyldimethoxysilane,
5-(meth)acryloxypentylmethyldiethoxysilane,
6-(meth)acryloxyhexyltrimethoxysilane,
6-(meth)acryloxyhexyltriethoxysilane,
6-(meth)acryloxyhexylmethyldimethoxysilane,
6-(meth)acryloxyhexylmethyldiethoxysilane,
7-(meth)acryloxyheptyltrimethoxysilane,
7-(meth)acryloxyheptyltriethoxysilane,
7-(meth)acryloxyheptylmethyldimethoxysilane,
7-(meth)acryloxyheptylmethyldiethoxysilane,
8-(meth)acryloxyoctyltrimethoxysilane,
8-(meth)acryloxyoctyltriethoxysilane,
8-(meth)acryloxyoctylmethyldimethoxysilane,
8-(meth)acryloxyoctylmethyldiethoxysilane,
9-(meth)acryloxynoryltrimethoxysilane,
9-(meth)acryloxynonyltriethoxysilane,
9-(meth)acryloxynonylmethyldimethoxysilane,
9-(meth)acryloxynonylmethyldiethoxysilane,
10-(meth)acryloxyecyltrimethoxysilane,
10-(meth)acryloxydecyltrimethoxysilane,
10-(meth)acryloxydecylmethyldimethoxysilane,
10-(meth)acryloxydecylrmethyldiethoxysilane,
11-(meth)acryloxyundecyltrimethoxysilane,
11-(meth)acryloxyurndecyltriethoxysilane,
11-(meth)acryloxyundecylmethyldimethoxysilane,
11-(meth)acryloxyundecylrnethyldiethoxysilane,
12-(meth)acryloxydodecyltrimethoxysilane,
12-(meth)acryloxydodecyltriethoxysilane,
12-(meth)acryloxydodecymethyldimethoxysilane,
12-(meth)acryloxydodecylmethyldiethoxysilane,
13-(meth)acryloxytridecyltrimethoxysilane,
13-(meth)acryloxytridecyltriethoxysilane,
13-(meth)acryloxytridecylmethyldimethoxysilane,
13-(meth)acryloxytridecylmethyldiethoxysilane,
14-(meth)acryloxytetradecyltrimethoxysilane,
14-(meth)acryloxytetradecyltriethoxysilane,
14-(meth)acryloxytetradecylmethyldimethoxysilane, and
14-(meth)acryloxytetradecylmethyldiethoxysilane.

Silane-based coupling agents are not limited to these. For example, silane-based coupling agents are available from silicone manufactures such as Shin-Etsu Silicone Co., Ltd. Among the silane-based coupling agents mentioned above, 3-methacryloxypropylmethyldimethoxysilane, 3-methacryloxypropyltrimethoxysilane, 3-methacryloxypropylmethyldiethoxysilane, 3-methacryloxypropyltriethoxysilane, 8-methacryloxyoctyltriethnoxysilane, and 3-acryloxypropyltrimethoxysilane are preferred.

Examples of the titanate-based coupling agent include PLENACT ITS, PLENACT 46B, PLENACT 55, PLENACT 41B, PLENACT 383, PLENACT 138S, PLENACT 238S, PLENACT 338X, PLENACT 44, PLENACT 9SA, and PLENACT ET, manufactured by Ajinomoto Fine-Techno Co., Inc., although titanate-based coupling agents are not limited to these.

Examples of the aluminate-based coupling agent include PLENACT AL-M, manufactured by Ajinomoto Fine-Techno Co., Inc., although aluminate-based coupling agents are not limited to these.

Examples of the zirconate-based coupling agent include ORGATIIX ZA-45, ORGATIX ZA-65, ORGATIX ZC-150, ORGATIX ZC-540, ORAOTIX ZC-700, ORGATIX ZC-200, ORGATIX ZC-320, ORGATIX ZC-126, and ORGATIX ZC-300, manufactured by Matsumoto Fine Chemical Co., Ltd., although zirconate-based coupling agents are not limited to these.

Examples of the isocyanate-based compound include ethyl isocyanate, propyl isocyanate, isopropyl isocyanate, butyl isocyanate, tert-butyl isocyanate, hexyl isocyanate, dodecyl isocyanate, octadecyl isocyanate, cyclophenyl isocyanate, cyclohexyl isocyanate, benzyl isocyanate, phenyl isocyanate, 4-butylphenyl isocyanate, 2-isocyanatoethyl methacrylate, 2-isocyanatoethyl acrylate, and 1,1-(bisacryloylozymethyl) ethyl isocyanate, although isocyanate-based compounds are not limited to these.

The hollow particles of the present invention may be surface-treated with an α,β-unsaturated carbonyl compound according to need. As the a, α,β-unsaturated carbonyl compound, (meth)acrylic acid ester-based compounds are preferred because the reactivity can be easily controlled.

Examples of (meth)acrylic acid ester-based compounds include mono(meth)acrylic acid ester-based compounds, di(meth)acrylic acid ester-based compounds, tri (meth)acrylic acid ester-based compounds, poly (meth)acrylic acid ester-based compounds, and the like.

By using a di(meth)acrylic acid ester-based compound, a tri (meth)acrylic acid ester-based compound, or a poly (meth)acrylic acid ester-based compound as a surface treating agent of the hollow particles of the present invention, an acryloyl group can be introduced into the crosslinked polymer mentioned above. Furthermore, by further allowing a compound to react with this (meth)acryloyl group according to need, other characteristics can be imparted to the hollow particles of the present invention.

Although not particularly limited, glycol (meth)acrylate-based compounds are suitable as mono (meth)acrylic acid ester-based compounds. By using a glycol (meth)acrylate-based compound for surface treatment of the hollow particles, the dispersibility of the hollow particles in a binder can be further increased.

Although not particularly limited, examples of glycol (meth)acrylate-based compounds include polyethylene glycol (meth)acrylate, poly (propylene glycol) (meth)acrylate, methoxy-poly (ethylene glycol) (meth)acrylate, ethoxy-poly (ethylene glycol) (meth)acrylate, poly (ethylene glycol) di(meth)acrylate, and the like.

Although not particularly limited, examples of di(meth)acrylic acid ester-based compounds and tri (meth)acrylic acid ester-based compounds include ethylene glycol di(meth)acrylate, diethylene glycol di(meth)acrylate, poly (ethylene glycol) di(meth)acrylate, propylene glycol di(meth)acrylate, pentaerythritol tri (meth)acrylate, and the like.

The surface treating agent may be used alone or in combination of two or more of these.

<Other Additives>

As long as the effects of the present invention are not impaired, the hollow particles of the present invention may contain additives such as pigment particles (pigments), dyes, stabilizers, UV ray absorbers, defoamers, thickeners, heat stabilizers, leveling agents, lubricants, and antistatic agents.

The pigment particles are not particularly limited as long as they are pigment particles used in the related technical field. For example, particles of iron oxide-based pigments such as micaceous iron oxide and iron black; lead oxide-based pigments such as red lead and chrome yellow; titanium oxide-based pigments such as titanium white (rutile-type titanium dioxide), titanium yellow, and titanium black; cobalt oxide; zinc oxide-based pigments such as zinc yellow; molybdenum oxide-based pigments such as molybdenum red and molybdenum white, and the like may be mentioned. Pigment particles may be used alone or in combination of two or more of these.

<Applications of Hollow Particles>

The hollow particles of the present invention are useful as additives for coating agents (coating compositions) used for paints, paper, information recording paper, light diffusion films (optical sheets), heat-insulating films, thermoelectric conversion materials, light guide olate inks, anti-reflective films, and light extraction films, which are applications where increased pH variation resistance and dispersibility are desired; additives of master pellets for forming shaped bodies such as light diffusion plates or light guide plates; and additives for cosmetics.

<Coating Agent>

The coating agent of the present invention at least contains the hollow particles. The coating agent may contain any binder.

The binder is not particularly limited, and known binder resins may be used. Examples of binder resins include thermosetting resins, thermoplastic resins, and the like. More specific examples thereof include fluororesins, polyamide resins, acrylic resins, polyurethane resins, acrylic urethane resins, butyral resins, and the like. These binder resins may be used alone or in combination of two or more of these. In addition, the binder resin may be a homopolymer of one reactive monomer or may be a copolymer of a plurality of monomers.

Examples of reactive monomers used in the binder include
monofunctional reactive monomers such as esters of a (meth)acrylic acid and an alcohol with 1 to 25 carbon atoms, including methyl (meth)acrylate, ethyl (meth)acrylate, propyl (meth)acrylate, n-butyl (meth)acrylate, isobutyl (meth)acrylate, tert-butyl (meth)acrylate, pentyl (meth)acrylate, (cyclo) hexyl (meth)acrylate, heptyl (meth)acrylate, (iso) octyl (meth)acrylate, nonyl (meth)acrylate, (iso) decyl (meth)acrylate, norbornyl (meth)acrylate, isobornyl (meth)acrylate, adamantyl (meth)acrylate, lauryl (meth)acrylate, tetradecyl (meth)acrylate, (iso) stearyl (meth)acrylate, isobornyl (meth)acrylate, phenoxyethylene glycol (meth)acrylate, phenoxydiethylene glycol (meth)acrylate, 2-ethylhexyl (meth)acrylate, and the like; and
polyfunctional reactive monomers such as trimethylolpropane tri (meth)acrylate, tripropylene glycol di(meth)acrylate, diethylene glycol di. (meth)acrylate, dipropylene glycol di(meth)acrylate, pentaerythritol tri (meth)acrylate, pentaerythritol tetra (meth)acrylate, dipentaerythritol hexa (meth)acrylate, 1, 6-hexanediol di(meth)acrylate, neopentyl glycol di(meth)acrylate, trimethylolpropane tri (meth)acrylate, ditrimethylolpropane tetra (meth)acrylate, dipentaerythritol penta (meth)acrylate, tripentaerythritol octa(meth)acrylate, tetrapentaerythritol deca (meth)acrylate, isocyanuric acid tri (meth)acrylate, isocyanuric acid di(meth)acrylate, polyester tri (meth)acrylate, polyester di(meth)acrylate, bisphenol di(meth)acrylate, diglycerine tetra(meth)acrylate, adamantyl. di(meth)acrylate, isobornyl di(meth)acrylate, dicyclopentane di(meth)acrylate, tricyclodecane di(meth)acrylate, and ditrimethylolpropane tetra (meth)acrylate.

When these reactive monomers are used, a polymerization initiator that initiates a curing reaction by ionizing radiation may be used. For example, imidazolo derivatives, bisimidazole derivatives, N-arylglycine derivatives, organic azide compounds, titanocenes, aluminate complexes, organic peroxides, N-alkoxypyridinium salts, thioxantone derivatives, and the like may be mentioned.

For example, inorganic binders such as hydrolyzates of silicon alkoxides can also be used as binders. Examples of silicon alkoxides include tetramethoxysilane, tetraethoxysilane, methyltrimethoxysilane, methyltriethoxysilane, 3-aminopropyltrimethoxysilane, 3-aminopropyltriethoxysilane, 2-hydroxyethyltrimethoxysilane, 2-hydroxyethyltriethoxysilane, 2-hydroxypropyltrimethoxysilane, 2-hydroxypropyltriethoxysilane, hydroxypropyltrimethoxysilane, 3-hydroxypropyltriethoxysilane, vinyltrimethoxysilane, -vinyltriethoxysilane, vinyltriacetoxysilane, allyltrimethoxysilane, 3-acryloxypropyltrimethoxysilane, 3-methacryloxypropylmethyldimethoxysilane, 3-methacryloxytrimethoxysilane, 3-methacryloxypropylmethyldiethoxysilane, 3-methacryloxypropyltriethoxysilane, 3-mercaptopropyltrimethoxysilane, mercaptopropylmethyldimethoxysilane, 3-mercaptopropyltriethoxysilane, 3-isocyanatopropylpropyltrimethoxysilane, 3-isocyanatopropyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, -(meth)acryloxypropyltrimethoxysilane, 3-(meth)acryloxypropyltriethoxysilane, 3-ureidopropyltrimethoxysilane, 3-ureidopropyltriethoxysilane, dimethyldimethoxysilane, dimethyldiethoxysilane, diethyldimethoxysilane, and diethyldiethoxysilane.

As known binder products, Daiyanal LR-102, Daiyanal BR-106, or the like, manufactured by Mitsubishi Rayon Co., Ltd., may be mentioned, for example.

The content of the hollow particles in the coating agent is adjusted as appropriate according to the applications used, but can be used in a range of 0.1 to 1000 parts by mass in relation to 100 parts by mass of a binder.

The coating agent normally contains a dispersion medium. As the dispersion medium, both aqueous media and oil-based media can be used. Examples of oil-based media include hydrocarbon solvents such as toluene and xylene; ketone solvents such as methyl ethyl ketone and methylisobutyl ketone; ester solvents such as ethyl acetate and butyl acetate; ether solvents such as dioxane and ethylene glycol diethyl ether; and the like. Examples of aqueous media include water and alcohol solvents.

Furthermore, the coating agent may contain other additives such as curing agents, coloring agents, antistatic agents, or leveling agents.

A substrate to be coated with the coating agent is not particularly limited, and a substrate according to applications may be used. For example, transparent substrates such as glass substrates and transparent resin substrates are used in optical applications.

<Master Pellet>

A master pellet contains the hollow particles and a base resin.

Base resins are not particularly limited as long as they are normal thermoplastic resins, and examples thereof include (meth)acrylic resins, alkyl (meth)acrylate-styrene copolymer resins, polycarbonate resins, polyester resins, polyethylene resins, polypropylene resins, polystyrene resins, and the like. When transparency is require, (meth)acrylic resins, alkyl (meth)acrylate-styrene copolymer resins, polycarbonate resins, and polyester resins are preferred. These base resins may be used alone or in combination of two or more of these. The base resin may contain a small amount of additives such as UV ray absorbers, heat stabilizers, coloring agents, and fillers.

The master pellet can be produced by melt-kneading the hollow particles and a base resin and molded by a molding method such as extrusion molding or inject ion molding. The blending proportion of the hollow particles in a master pellet is not particularly limited, but preferably about 0.1 to 60% by weight, more preferably about 0.3 to 30% by weight, and still more preferably about 0.4 to 10% by weight.

The master pellet is shaped into a molded body by, for example, extrusion molding, injection molding, or cress molding. Alternatively, a base resin may be newly added during molding. The amount of the base resin to be added is preferably such that the blending proportion of the hollow particles contained in the finally obtainable molded article is about 0.1 to 60% by weight. During molding, a small amount of additives such as UV ray absorbers, heat stabilizers, coloring agents, and fillers may be added.

<Cosmetics>

Specific cosmetics in which the hollow particles of the present invention can be blended include solid cosmetics such as face powder and foundation, powder cosmetics such as baby powder and body powder, liquid cosmetics such as lotion, milky lotion, cream, and body lotion, and the like.

The blending proportion of hollow particles in these cosmetics depends on the type of cosmetics. For example, in the case of solid cosmetics such as face powder and foundation, the blending proportion is preferably 1 to 20% by weight and more preferably 3 to 15% by weight. For powder cosmetics such as baby powder and body powder, the blending proportion is preferably to 20% by weight and more preferably 3 to 15% by weight. For liquid cosmetics such as lotion, milky lotion, cream, liquid foundation, body lotion, and pre-shave lotion, the blending proportion is preferably 1 to 15% by weight and more preferably 3 to 10% by weight.

Inorganic compounds such as mica or talc, coloring pigments such as iron oxide, titanium oxide, ultramarine blue, navy blue, or carbon black, or synthetic dyes of azo type, etc., may be added to these cosmetics in order to increase optical functions and tactile sensation. For liquid cosmetics, water, alcohols, hydrocarbons, silicone oils, vegetable or animal fats and oils, or the like may also be used as liquid media, although the liquid media are not particularly limited thereto. In addition to the other ingredients listed above, moisturizers, anti-inflammatory agents, whitening agents, UV care agents, disinfectants, antiperspirants, cooling agents, fragrances, or the like, which are commonly used in cosmetics, may also be added to these cosmetics so as to add various functions.

<Antireflection Film>

The antireflection film of the present invention at least contains the hollow particles. Films or sheet-like shaped articles containing the hollow particles can be used as antireflection films because the refractive index is reduced due to the air layer in the hollow portion of the hollow particles. In addition, since the hollow particles have high heat resistance, an antireflection film with high heat resistance can be obtained. The anti-reflective films may be obtained by coating the coating agent mentioned above on a substrate by a well-known method such as a dipping method, a spraying method, a spin coating method, a spinner method, or a roll coat method, drying the coated film, and further heating, UV-irradiating, or firing the coated film according to need.

<Antireflection Film-Attached Substrate>

An antireflection film-attached substrate of the present invention has the antireflection film mentioned above formed on the surface of a substrate of glass; a substrate of a plastic sheet, a plastic film, a plastic lens, or a plastic panel of polycarbonate, acrylic resins, PET, or TAC; or a substrate of cathode ray tubes, vacuum fluorescent displays, or liquid crystal displays. Depending on the application, a coating film is formed alone or on the substrate in combination with a protective film, a hard coat film, a flattened film, a high refractive index film, an insulating film, a conductive resin film, a conductive metal fine particle film, a conductive metal oxide fine particle film, and other primer films used according to need. When used in combination, the antireflection film does not necessarily have to be formed on the outermost surface.

<Tight Extraction Film>

The light extraction film of the present invention at least contains the hollow particles. In LED or organic EL lightning, the emitted light will likely be trapped inside the device due to the large refractive index difference between the air layer and the light-emitting layer. Thus, a light extraction film is used for the purpose of increasing the light emitting efficiency. Films or sheet-like shaped articles containing the hollow particles can be used as light extraction films because the refractive index is: reduced due to the air layer in the hollow portion of the hollow particles. In addition, since the hollow particles have high heat resistance, a light extraction film with high heat resistance can be obtained. The light extraction films may be obtained by coating the coating agent mentioned above on a substrate with a well-known method such as a dipping method, a spraying method, a spin coating method, a spinner method, or a roll coat method, drying the coated film, and further heating, UV-irradiating, or firing the coated film according to need.

<Light Extraction Film-Attached Substrate>

A light extraction film-attached substrate of the present invention has the light extraction film mentioned above formed on the surface of a substrate of glass; a substrate of a plastic sheet, a plastic film, a plastic lens, or a plastic panel of polycarbonate, acrylic resins, PET, or TAC; or a substrate of cathode ray tubes, vacuum fluorescent displays, or liquid crystal displays. Depending on the application, a coating film is formed alone or on the substrate in combination with a protective film, a hard coat film, a flattened film, a high refractive index film, an insulating film, a conductive resin film, a conductive metal fine particle film, a conductive metal oxide fine particle film, and other primer films used according to need. When used in combination, the light extraction film does not necessarily have to be formed on the outermost surface.

<Heat-Insulating Film>

The heat-insulating film of the present invention at least contains the hollow particles. Films or sheet-like shaped articles containing the hollow particles can be used as heat-insulating films because the films or sheet-like shaped articles have an air layer in the hollow portion of the hollow particles. Furthermore, since the particle diameter of the hollow particles is small, a heat-insulating film with high transparency is obtained, and since a binder does not easily penetrate into the hollow portion, a heat-insulating film with high heat-insulating properties is likely to be obtained. The heat-insulating films may be obtained by coating the coating agent mentioned above on a substrate with a well-known method such as a dipping method, a spraying method, a spin coating method, a spinner method, or a roll coat method, drying the coated film, and further heating, UV-irradiating, or firing the coated film according to need.

<Low Dielectric Constant Film>

The low dielectric constant film of the present invention at least contains the hollow particles. Films or sheet-like shaped articles containing the hollow particles can be used as low dielectric constant films because the films or sheet-like shaped articles have an air layer in the hollow portion of the hollow particles. Furthermore, since the particle diameter of the hollow particles is small, a low dielectric constant film with high transparency is likely to be obtained. The low dielectric constant films may be obtained by coating the coating agent mentioned above on a substrate by a well-known method such as a dipping method, a spraying method, a spin coating method, a spinner method, or a roll coat method, drying the coated film, and further heating, UV-irradiating, or firing the coated film according to need.

<Photosensitive Resin Composition>

The photosensitive resin composition of the present invention at least contains the hollow particles. A photosensitive resin composition including the hollow particles has an air layer in the hollow portion of the hollow particles. Therefore, a photosensitive resin composition with a low refractive index can be obtained. Furthermore, since the particle diameter of the hollow particles is small, a photosensitive resin composition with high transparency is likely to be obtained. The photosensitive resin composition may be obtained by coating the coating agent mentioned above on a substrate with a well-known method such as a dipping method, a spraying method, a spin coating method, a spinner method, or a roll coat method, drying the coated film, and further heating, UV-irradiating, or firing the coated film according to need.

<Production Method of Hollow Particles>

The hollow particles of the present invention can be produced, for example, through a step of preparing polymer particles containing a non-reactive solvent (polymerization step), a step of phase-separating the non-reactive solvent from the polymer particles (phase separation step), and a step for removing the non-reactive solvent (solvent removal step).

The production method of the hollow particles may be a method in which the polymerization step and the phase separation step are simultaneously performed by reacting a reactive monomer or may be a method in which polymer particles are once formed before the phase separation of the non-reactive solvent, and then the phase separation is made to occur. Using a method in which polymer particles are once formed and then the phase separation is made to occur is preferable because the occurrence of pinholes can be suppressed, and the monodispersity can be increased.

Specifically, in a method in which polymer particles are once formed before the phase separation of the non-reactive solvent and then the phase separation is made to occur, a reactive monomer with a (meth)acrylic-based reactive functional group and a non-(meth)acrylic-based reactive functional group is polymerized based on either one of the two functional groups to prepare polymer particles. The non-reactive solvent is included in the polymer particles by mixing the solvent with a reactive monomer in advance or allowing the solvent to be absorbed into the polymer particles after the preparation of polymer particles. Next, polymerization based on the other remaining functional group of the above two functional groups results in phase separation of the polymer and the non-reactive solvent to produce microcapsule particles encapsulating the non-reactive solvent. The hollow particles are then obtained by removing the non-reactive solvent.

As stated above, by separating the polymerization step and the phase separation step, it is advantageous in the following points:
Gaps between the polymeric materials in the shell, which existed in the conventional production method, are no longer present, and the occurrence of pinholes in the shell of the resulting hollow particles: can be suppressed.
The shape of the microcapsule particles or hollow particles does not depend on oil droplets but depends on the shape of the polymer particles before phase separation and the particle size distribution, and therefore, microcapsule particles or hollow particles with high monodispersity is likely to be obtained. This production method is described below.

(A) Polymerization Step

In the polymerization step, a reactive monomer with a (meth)acrylic-based reactive functional group and a non-(meth)acrylic-based reactive functional group is polymerized based on either one of the two functional groups to prepare polymer particles. The non-reactive solvent is included in the polymer particles by mixing the solvent with a reactive monomer in advance or allowing the solvent to be absorbed after the preparation of polymer particles.

(a) Preparation Method of Polymer Particles

As a preparation method of polymer particles, any method can be adopted among known methods, such as bulk polymerization methods, solution polymerization methods, dispersion polymerization methods, suspension polymerization methods, and emulsion polymerization methods. Among them, suspension polymerization methods and emulsion polymerization methods are preferred because polymer particles can be prepared relatively easily. Furthermore, emulsion polymerization methods are more preferred because polymer particles with high monodispersity can be easily obtained.

<Polymerization Initiator>

In polymerization, adding a compound to react the functional group to be polymerized is preferred. When a (meth)acrylic-based reactive functional group is polymerized, a polymerization initiator can be used for this compound. Although not particularly limited, examples of polymerization initiators include persulfates such as ammonium persulfate (ammonium peroxodisulfate), potassium persulfate, and sodium persulfate; organic peroxides such as cumene hydroperoxide, di-tert-butyl peroxide, dicumyl peroxide, benzoyl peroxide, lauroyl peroxide, dimethyl bis (tert-butylperoxy) hexane, dimethyl bis (tert-butylperoxy) hexyne-3, bis (tert-butylperoxyisopropyl) benzene, bis (tert-butylperoxy) trimethylcyclohexane, butyl-bis (tert-butylperoxy) valerate, tert-butyl peroxy-2-ethylhexanoate, dibenzoyl peroxide, p-menthane hydroperoxide, and tert-butyl peroxybenzoate; and azo compounds such as 2,2-azobis[2-(2-imidazolin-2-yl) propane] dihydrochloride, 2, 2-azobis [2-(2-imidazol in--yl)propane] disulfate dihydrate, 2, 2-azobis (2-amidinopropane) dihydrochloride, 2,2-azobis [N-(2-carboxyethyl)-2-methylpropionamidine] hydrate, 2, 2-azobis {2-[1-(2-hydroxyethyl)-2-imidazolin-2-yl]propane}dihydrochloride, 2, 2-azobis [2-(2-imidazolin-2-yl)propanel, 2,2-azobis (-imino-1-pyrrolidino-2-ethylpropane) dihydrochloride, 2, 2-azobis(2-methyl-N-[,1-bis (hydroxymethyl)-2-hydroxyethyl]propionamide}, 2, 2-azobis [2-methyl-N-(2-hydroxyethyl) propionamide], 4, 4-azobis (4-cyanopentanoic acid), 2, 2-azobis (isobutyronitrile) (2, 2-azobis (2-methyl-butyronitrile)), 2,2-azobis (2-isopropylbutyronitrile), 2,2-azobis (2,3-dimethylbutyronitrile), 2, 2-azobis (2, 4-dimethylbutyronitrile), 2, 2-azobis (2-methylcapronitrile), 2,2-azobis (2,3,3-trimethylbutyronitrile), 2, 2-azobis (2, 4, 4-trimethylvaleronitrile), 2, 2-azobis (2, 4-dimiethylvaleronitrile), 2, 2-azobis (2, 4-dimethyl-4-methoxyvaleronitrile), 2,2-azobis (2, 4-dimethyl-4-n-butoxyvaleronitreile), 2, 2-azobis (4-methoxy-2, 4-dimethylvaleronitrile), 2, 2-azobis (N-(2-propenyl)-2-methylpropionamide], 2, 2-azobis (N-butyl-2-methylpropionamide), 2, 2-azobis (N-cyclohexyl-2-methylpropionamide), 1, 1-azobis (1-acetoxy-1-phenylethane), 1, -azobis (cyclohexane-1-carbonitrile), dimethyl-2, 2-azobis (2-methylpropionate), dimethyl-2, 2-azobis (isobutyrate), dimethyl-2, 2′-azobis (2-methylpropionate), 2-(carbamoylazo) isobutyronitrile, 4, 4-azobis (4-cyanovaleric acid); and the like. These polymerization initiators may be used alone or in combination of two or more of these.

In addition, a redox initiator including a polymerization initiator of the persulfate salts and organic peroxides mentioned above and a reducing agent, such as sodium formaldehyde sulfoxylate, sodium hydrogen sulfite, ammonium hydrogen sulfite, sodium thiosulfate, ammonium thiosulfate, hydrogen peroxide, sodium hydroxymethanesulfinate, L-ascorbic acid and a salt thereof, and a cuprous salt, a ferrous salt may be used in combination, may be used as a polymerization initiator.

In the case of emulsion polymerization, a water-soluble polymerization initiator that allows emulsion polymerization to be performed under an aqueous solution is preferred as the polymerization initiator. Although not particularly limited, examples of water-soluble polymerization initiators include persulfates such as ammonium persulfate (ammonium peroxodisulfate), potassium persulfate, and sodium persulfate; and azotized compounds such as 2, 2-azobis [2-(2-imidazolin-2-yl) propane] dihydrochloride, 2, 2-a zobis [2-(2-imidazolin-2-yl)propane] disulfate dihydrate, 2,2-azobis (2-amidinopropane) dihydrochloride, 2, 2-azobis [N[-(2-carboxyethyl)-2-methylpropionamidine] hydrate, 2, 2-azobis {2-[1-(2-hydroxyethyl)-2-imidazolin-2-yl propane f dihydrochloride, 2, 2-azobis [2-(2-imidazolin-2-yl) propane], 2, 2-a zobis (1-imino-1-pyrrolidino-2-ethylpropane) dihydrochloride, 2, 2-azobis {2-methyl-N-[1, 1-bis (hydroxymethyl)-2-hydroxyethyl)propionamide}, 2,2-azobis [2-methyl-N-(2-hydroxyethyl)propionamide], and 4, 4-azobis (4-cyanopentanoic acid); and the like.

The polymer particles are preferably polymerized based on (meth)acrylic-based reactive functional groups first so as to have an unreacted non-(meth)acrylic-based reactive functional group in the polymer particles. If the polymerization is based on the non-(meth)acrylic-based reactive functional groups first, non-reactive solvents may be less likely to be absorbed in some cases.

<Chain Transfer Agent>

A chain transfer agent may be used during the polymerization of reactive monomers. The chain transfer agent is not particularly limited, but, for example, alkyl mercaptans such as n-hexyl mercaptan, n-octyl mercaptan, tert-octyl mercaptan, n-dodecyl mercaptan, and tert-dodecyl mercaptan; phenolic compounds such as an u-methylstyrene dimer, 2, 6-di-tert-butyl-4-methylphenol, and styrenated phenol; allyl compounds such as allyl alcohol; halogenated hydrocarbon compounds such as d-chloromethane, dibromomethane, and carbon tetrachloride; and the like. These chain transfer agents may be used alone or in combination of two or more or these. The upper limit or a chain transfer agent used is 10 parts by mass in relation to 100 parts by mass of reactive monomers.

<Surfactant>

A surfactant may be used during the polymerization of reactive monomers. The type of the surfactant is not particularly limited, and, for example, known surfactants may be widely adopted. Examples of surfactants include anionic surfactants, cationic surfactants, amphoteric surfactants, and non-ionic surfactants. These surfactants may be used alone or in combination of two or more of these. Among these surfactants, anionic surfactants are preferred. The upper limit of a surfactant used is 5 parts by mass in relation to 100 parts by mass of reactive monomers.

As anionic surfactants, known commercial products may be widely used. Examples of commercial products that can be used include the product name “AQUALON AR-1025”, manufactured by DKS CO. Ltd.

<Dispersing Aid>

When the polymer particles are prepared, a hydrophilic monomer may be used as another reactive monomer than (meth)acrylic-based reactive monomers. Since hydrophilic monomers serve as dispersion aids, using hydrophilic monomers can increase dispersion stability during polymerization. The type of the hydrophilic monomer is not particularly limited, and, for example, known hydrophilic monomers may ne widely adopted. Examples of hydrophilic monomers include carboxyl group-containing vinylic monomers and salts thereof; sulfone group-containing vinylic monomers and vinylic sulfuric acid monoesterified products, and salts of these; phosphate group-containing vinylic monomers and salts thereof; hydroxyl group-containing vinylic monomers; nitrogen-containing vinylic monomers, and the like. These hydrophilic monomers may be used alone or in combination of two or more of these.

Examples of carboxyl group-containing vinylic monomers include maleic acid (or maleic anhydride), maleic acid monoalkyl ester, fumaric acid, fumaric acid monoalkyl ester, crotonic acid, itaconic acid, itaconic acid monoalkyl esters, itaconic acid glycol monoethers, citraconic acid, citraconic acid monoalkyl esters, cinnamic acid, and salts of these, and the like. Examples of the salts of these include alkali metal salts (sodium salts, potassium salts, etc.), ammonium salts, amine salts, quaternary ammonium salts of the above-mentioned carboxyl group-containing vinylic monomers, and the like. The carboxyl group-containing vinyl: monomer and salts thereof may be used alone or in combination of two or more of these.

Examples of sulfone group-containing vinylic monomers and vinylic sulfuric acid monoesterified products include vinyl sulfonic acid, (meth) allylsulfonic acid, p-styrenesulfonic: acid, sulfopropyl (meth)acrylate, 2-hydroxy-3-(meth)acryloxypropylsulfonic acid, 2-(meth)acryloylamino-2, 2-dimethylethanesulfonic acid, 2-(meth)acryloyloxyethanesulfonic acid, 3-(meth)acryloyloxy-2-hydroxypropanesulfonic acid, 2-(meth)acrylamido-2-methylpropanesulfonic acid, 3-(meth)acrylamido-2-hydroxypropanesulfonic acid, alkyl (C3-18) allyl sulfosuccinic acid, sulfuric acid ester of poly (n=2 to 30) oxyalkylene (ethylene, propylene, buthylene, etc.; homo, random, or block) mono (meth)acrylate [poly (n=5 to 15) oxypropylene monomethacrylate sulfuric acid ester, etc.], and the salts of these, and the like. Examples of the salts of these include alkali metal salts (sodium salts, potassium salts, etc.), ammonium salts, amine salts, quaternary ammonium salts of the above-mentioned sulfone group-containing vinylic monomer and vinylic sulfuric acid monoesterified products. The sulfone group-containing vinylic monomers and vinylic sulfuric acid monoesterified products, and the salts of these may be used alone or in combination of two or more of these. Among the above-mentioned sulfone group-containing vinylic monomers and vinylic sulfuric acid monoesterified products, and the salts of these, sodium p-styrenesulfonate is preferred from the viewpoint of further enhancing dispersion stability during polymerization.

Examples of phosphate group-containing vinylic monomers include 2-hydroxyethyl (meth)acryloylphosphate, phenyl-2-acryloyloxyethyl phosphate, etc., and salts of these, and the like. Examples of the salts of these include alkali metal salts (sodium salts, potassium salts, etc.), ammonium salts, amine salts, and quaternary ammonium salts of the phosphate group-containing vinylic monomer mentioned above. The phosphate group-containing vinylic monomers and salts thereof may be used alone or in combination of two or more of these.

Examples of hydroxyl group-containing vinylic monomers include hydroxystyrene, N-methylol (meth)acrylamide, hydroxyethyl (meth)acrylate, hydroxypropyl (meth)acrylate, polyethylene glycol mono (meth)acrylate, (meth) allyl alcohol, and the like. The hydroxyl group-containing vinylic monomers may be used alone or in combination of two or more of these.

Examples of nitrogen-containing vinylic monomers include quaternized products (which are quaternized using a quaternizing agent such as methyl chloride, dimethyl sulfate, benzyl chloride, dimethyl carbonate, and the like) of tertiary amine group-containing vinylic monomers, such as aminoethyl (meth)acrylate, dimethylaminoethyl (meth)acrylate, diethylaminoethyl (meth)acrylate, (meth)acrylamide, N-methyl (meth)acrylamide, H-butylacrylamide, diacetone acrylamide, (meth)acrylonitrile, dimethylaminoethyl (meth)acrylate, diethylaminoethyl (meth)acrylamide, and the like.

(b) Absorption of Non-Reactive Solvent

Absorption of the non-reactive solvent into the polymer particles can be carried out during or after the production of the polymer particles. Absorption of a non-reactive solvent may be carried out under the presence or absence of a dispersion medium incompatible with the non-reactive solvent. It is preferred to carry out the absorption process under the presence of a dispersion medium because the absorption of the non-reactive solvent can be more efficiently performed. When a medium is used in the production method of the polymer particles, the medium may be used as it is as a dispersion medium, or after once isolating polymer particles from the medium, the polymer particles may be dispersed in another dispersion medium.

A non-reactive solvent incompatible with a dispersion medium containing the polymer particles is added to the dispersion medium, and a non-reactive solvent is allowed to be absorbed into the polymer particles under stirring for a certain period of time, etc.

Absorption of a non-reactive solvent during producing the polymer particles can be achieved by selecting a dispersion medium and a non-reactive solvent suitable for preparing the polymer particles. For example, when the polymer particles are prepared by emulsion polymerization under the presence of an aqueous solvent, preparation of polymer particles and absorption of polymer particles can be carried out simultaneously by adding a non-reactive solvent incompatible with water to the aqueous solvent in advance and polymerizing a reactive monomer. When the preparation of polymer particles and absorption of polymer particles are carried out simultaneously, the time for absorbing a non-reactive solvent can be saved.

<Dispersion Medium>

A dispersion medium is not particularly limited as long as it is a liquid that does not completely dissolve the polymer particles. For example, ion-exchanged water; alcohols such as ethyl alcohol, methyl alcohol, and isopropyl alcohol; alkanes such as butane, pentane, hexane, cyclohexane, heptane, decane, and hexadecane; aromatic hydrocarbons such as toluene and xylene; ester solvents such as ethyl acetate and butyl acetate; ketone solvents such as methyl ethyl ketone and methyl isobutyl ketone; and halogen-containing solvents such as methyl chloride, methylene chloride, chloroform, and carbon tetrachloride. These dispersion media may be used alone or in combination of two or more of these.

<Non-Reactive Solvent>

A non-reactive solvent is not particularly limited as long as it is a liquid incompatible with a dispersion medium. The term “incompatible with a dispersion medium” herein means that the solubility (at 25° C.) of the non-reactive solvent in a dispersion medium is 10% by weight or less. For example, when ion-exchanged water is used as a dispersion medium, non-reactive solvents that can be used include butane, pentane, hexane, cyclohexane, heptane, decane, hexadecane, toluene, xylene, ethyl acetate, butyl acetate, methyl ethyl ketone, methyl isobutyl ketone, 1, 4-dioxane, methyl chloride, methylene chloride, chloroform, carbon tetrachloride, and the like. These non-reactive solvents may be used alone or in combination of two or more of these.

The amount of the non-reactive solvent added is not particularly limited, but is 20 to 5000 parts by mass in relation to 100 parts by mass of the polymer particles. When the amount is less than 20 parts by mass, the hollow portion of the resulting macrocapsule particles or hollow particles may be small, and the desired characteristics may not be achieved in some cases. When the amount exceeds 5000 parts by mass, the hollow portion may be too large, and the strength of the resulting microcapsule particles or hollow particles may be low.

(B) Phase Separation Step

Next to the polymerization step, the remaining reactive functional group is polymerized so that the polymer and the non-reactive solvent are phase-separated. Microcapsule particles encapsulating the non-reactive solvent can be produced by phase separation. In the present description, the term “hollow” in the hollow particles is not only limited to the case where the air is present in the hollow portion, but also encompasses the cases where gases other than the air are present in the hollow portion. Furthermore, the hollow particles in the present description are not only limited to hollow particles with a gas present in the hollow portion but also include microcapsule particles with non-reactive solvents or other dispersion media present in the hollow portion.

A compound added to polymerize the remaining reactive functional groups may be the same as the polymerization initiators to polymerize (meth)acrylic-based reactive functional groups or crosslinking agents (crosslinking monomers) to polymerize non-(meth)acrylic-based reactive functional groups described in the polymerization step.

(C) Solvent Removal (Replacement) Step

The hollow particles of the present invention can be made as hollow particles with gases such as air or other solvents present in the hollow portion by removing or replacing the non-reactive solvent encapsulated in the microcapsule particles according to need. Methods for removing non-reactive solvents are not particularly limited, but reduced-pressure drying or the like can be mentioned. The condition of reduced-pressure drying is, for example, at a pressure of 500 Pa or less and a temperature of 30 to 200° C. for 30 minutes to 50 hours, in addition, a non-reactive solvent can be replaced by a solvent replacement operation. Examples of this operation include an operation in which microcapsule particles encapsulating the non-reactive solvent or a dispersion containing such microcapsule particles are added to a suitable dispersion medium, then the resulting mixture is stirred, etc., to replace the non-reactive solvent in the particles by the dispersion medium, and after that, the excess non-reactive solvent and dispersion medium are removed by reduced-pressure drying, centrifugal separation, ultrafiltration, and the like. Solvent replacement operation can be performed at once or multiple times.

(D) Surface Treatment Step

To the hollow particle dispersion liquid after the phase separation step, the hollow particle dispersion liquid after the solvent replacement step, or a hollow particle dispersion liquid in which the hollow particles after the solvent removal step are dispersed in a solvent, the surface treating agent is added and stirred to treat the surface of the hollow particles.

The hollow particles of the present invention may be dried by removing solvents from the dispersion liquid of the hollow particles and used as dried powder according to need. The drying method of the hollow particles is not particularly limited, but reduced-pressure drying or the like may be mentioned.

### EXAMPLES

The present invention will be specifically described below based on the Examples, but the present invention is not limited to the embodiments of these Examples. First, various measuring methods carried out in the Examples are described.

<Average Particle Diameter and Sphericity>

A hollow particle dispersion liquid was dried for four hours in a vacuum drier at 90° C., and after that, the resulting dried matter was crushed with a spatula to obtain a dried powder. The hollow particles were sprinkled onto a collodion film on the TEM grids (manufactured by Nisshin EM Co., Ltd,), then osmium staining was performed, and a TEM photograph was taken using a transmission electron microscope (“H-7600”, manufactured by Hitachi High-Technologies Corporation) at an accelerating voltage of 80 kV and a magnification of about 30000x. The longest diameter and the shortest diameter of any 30 particles photographed in this photograph were each observed. At this time, the longest diameter and the shortest diameter of any 30 particles were each measured, and the average [(the longest diameter+the shortest diameter)/2] was taken as the particle diameter of each particle. Then, the average of the particle diameters of these 30 particles was taken as the average particle diameter of the hollow particles.

Sphericity is defined as a ratio of the shortest diameter to the longest diameter and (shortest diameter/longest diameter) of the hollow particles. Specifically, the longest diameter and the shortest diameter of each of any 30 particles were measured, and the ratio of the shortest diameter to the longest diameter and (shortest diameter/longest diameter) was measured for each of the 30 particles, and the average of the ratios was used as sphericity.

<Hollow Ratio>

In a glass bottle, 0.2 g of 10%, by mass isopropyl alcohol dispersion liquid containing surface-treated hollow particles, 0.98 g of a carboxyl group-containing acrylic polymer (ARUFON UC-3510, with a molecule weight of about 2000, manufactured by Toagosei Co., Ltd.), and 0.5 g of methanol were weighed accurately and uniformly mixed using an ultrasonic cleaner. Next, the hollow particle dispersion liquid was dried at 90° C. for 16 hours by a vacuum dryer to volatilize and fully remove isopropyl alcohol and methanol contained in the system. The refractive index of the resulting acrylic polymer containing the hollow particles was measured using an Abbe's refractometer (manufactured by ATPAGO Co., Ltd,).

The refractive index Np of the hollow particles was calculated using the Maxwell-Garnett equation. The shell refractive index of the hollow nanoparticles was set to 1.537, the shell density was set to 1.27, the refractive index of the air was set to 1.00, and the density of the air was set to 0, and the Maxwell-Garnett equation was solved again, to thereby calculating the volume fraction (volume %) q (=hollow ratio) of the air in the hollow nanoparticles.

(Na²−Nm²)/(Na²+Nm²)=q(Np²−Nm²)/(Np²+Nm²) [Maxwell-Garnett Equation]

<3% Thermal Decomposition Temperature>

The measurement method of a 3% thermal decomposition temperature is as follows.

First, a hollow particle dispersion liquid was dried for four hours in a vacuum drier at 90° C., and after that, the resulting dried matter was crushed with a spatula to obtain a dried powder. Next, the resulting dried powder was thermogravimetrically measured using a simultaneous differential thermal-thermogravimetric apparatus (TG-DTA; “STA 200”, manufactured by Hitachi High-Tech Science Corporation). In this measurement, alumina was used as a standard substance, about 15 mg of the resulting dried powder was filled without gaps on the bottom of the aluminum measuring container, and a mass loss curve (a TG/DTA curve) when the temperature was raised from 40°_{C} to 800° C. at a temperature-rising rate of 10° C./min was obtained under the air flow rate of 200 mL/min. From the obtained curve, the temperature at which the mass was reduced by 3% was read based on the mass reduction curve obtained by the above measurement using an analysis software included in the above apparatus, and this read temperature was adopted as a 3% thermal decomposition temperature. In this measurement, in order to sufficiently suppress the influence on the measurement results by the moisture in the dried powder, the temperature was raised from 40° C. to 125°_{C} at a rate of 10° C./min under the air flow rate of 200 mL/min and the mass of the dried powder after rising the temperature was set to the standard mass, and the temperature at which the mass was reduced by 3% from the standard mass based on the mass loss curve was read, and the read temperature was adopted as a 3% thermal decomposition temperature (C).

### Example 1

In a 5-L stainless steel beaker, 3600 parts by mass or ion-exchanged water, 1.6 parts by mass of an anionic surfactant (a product name “AQUALON AR-1025”, manufactured by DKS CO. Ltd.), 4.0 parts by mass of sodium p-styrenesulfonate, and 4.0 parts by mass of ammonium peroxodisulfate were added and dissolved. To this stainless steel beaker, a mixed solution of 168 parts by mass of glycidyl methacrylate, 32 parts by mass of 3-methacryloxypropyltriethoxysilane, 4.0 parts by mass of n-octyl mercaptan, and 220 parts by mass of toluene were added, and the resulting mixture was stirred for 10 minutes at room temperature using an ultrasonic homogenizer (manufactured by Branson Ultrasonics Corporation, model type SONIIFIEIR 450) to prepare an emulsion. The adjusted emulsion was put in a 5-L reaction vessel equipped with a stirrer and a thermometer, and after nitrogen replacement to make the interior a nitrogen atmosphere, the temperature was raised to 70° C., The polymerization reaction was carried out at 70° C. for 2 hours while stirring. Next, 50.9 parts by mass of piperazine was added, then the temperature was raised to 80° C. under a nitrogen atmosphere, and after that, the reaction was carried out at 80° C. for 16 hours while stirring to prepare a hollow particle dispersion liquid.

Then, 4000 parts by mass of the resulting hollow particle dispersion liquid was washed by cross-flow washing with 20000 parts by mass of ion-exchanged water using a ceramic filter with a pore diameter of 50=nm, then the washed dispersion liquid was concentrated or ion-exchanged water was added thereto as appropriate such that the solid content be 10% by mass, to prepare a 10% by mass aqueous hollow particle dispersion liquid. In a 7-L stainless steel beaker, 120 parts by mass of Phosphanol RS-710 (manufactured by TOHO Chemical Industry Co., Ltd.) was weighed and dissolved in 2000 parts by mass of isopropyl alcohol. Next, 2000 parts by mass of 10% by mass aqueous hollow particle dispersion liquid was added, and the resulting mixture was stirred at room temperature for 30 minutes using an ultrasonic homogenizer. Then, the dispersion liquid was washed by cross-flow washing with 20000 parts by mass or isopropyl alcohol using a ceramic filter with a pore diameter of 50 nm, then the washed dispersion liquid was concentrated or isopropyl alcohol was added thereto as appropriate such that the solid content be 10 by mass, to prepare a 10% by mass isopropyl alcohol dispersion liquid containing hollow particles.

The resulting hollow particles had an average particle diameter of 105 nm, a sphericity of 0.96, and a hollow ratio of as high as 48.4%. Furthermore, the resulting hollow particles had a 3% thermal decomposition temperature of as high as 264° C.

### Example 2

In a 5-L stainless steel beaker, 3600 parts by mass or ion-exchanged water, 1.6 parts by mass of an anionic surfactant (a product name “AQUALON AR-1025”, manufactured by DKS CO. Ltd.), 6.0 parts by mass of sodium p-styrenesulfonate, and 8.0 parts by mass of ammonium peroxodisulfate were added and dissolved. To this stainless steel beaker, a mixed solution of 166 parts by mass of glycidyl methacrylate, 32 parts by mass of 3-methacryloxypropyltriethoxysilane, 4.0 parts by mass of n-octyl mercaptan, and 200 parts by mass of toluene were added, and the resulting mixture was stirred for 10 minutes at room temperature using an ultrasonic homogenizer (manufactured by Branson Ultrasonics Corporation, model type SONIFIEIR 450) to prepare an emulsion. The adjusted emulsion was put in a 5-L reaction vessel equipped with a stirrer and a thermometer, and after nitrogen replacement to make the interior a nitrogen atmosphere, the temperature was raised to 70° C. The polymerization reaction was carried out at 70° C. for 2 hours while stirring. Next, 6.6 parts by mass of propylenediamine and 41.4 parts by mass of N-methylpiperazine were added, then the temperature was raised to 80° C. under a nitrogen atmosphere, and after that, the reaction was carried out at 80° C. for 16 hours while stirring to prepare a hollow particle dispersion liquid.

Then, 4000 parts by mass of the resulting hollow particle dispersion liquid was washed by cross-flow washing with 20000 parts by mass of ion-exchanged water using a ceramic filter with a pore diameter of 50 nm, then the washed dispersion liquid was concentrated or ion-exchanged water was added thereto as appropriate such that the solid content be 10% by mass, to prepare a 10% by mass aqueous hollow particle dispersion liquid. In a 7-L stainless steel beaker, 120 parts by mass of Phosphanol RS-710 (manufactured by TOHO Chemical Industry Co., Ltd.) was weighed and dissolved in 2000 parts by mass of isopropyl alcohol. Next, 2000 parts by mass of 10% by mass aqueous hollow particle dispersion liquid was added, and the resulting mixture was stirred at room temperature for 30 minutes using an ultrasonic homogenizer. Then, the dispersion liquid was washed by cross-flow washing with 20000 parts by mass of isopropyl alcohol using a ceramic filter with a pore diameter of 50 nm, then the washed dispersion liquid was concentrated or isopropyl alcohol was added thereto as appropriate such that the solid content be 10% by mass, to prepare a 10% by mass isopropyl alcohol dispersion liquid containing hollow particles.

The resulting hollow particles had an average particle diameter of 109 nm, a sphericity of 0.97, and a hollow ratio of as high as 45.4%. Furthermore, the resulting hollow particles had a 3% thermal decomposition temperature of as high as 262° C.

### Example 3

In a 5-L stainless steel beaker, 3600 parts by mass of ion-exchanged water, 1.6 parts by mass of an anionic surfactant (a product name “AQUALON AR-1025”, manufactured by OKS CO. Ltd.) 6.0 parts by mass of sodium p-styrenesulfonate, and 8.0 parts by mass or ammonium peroxodisulfate were added and dissolved. To this stainless steel beaker, a mixed solution of 168 parts by mass of glycidyl methacrylate, 32 parts by mass of 3-methacryloxypropyltriethoxysilane, 4.0 parts by mass: of n-octyl mercaptan, and 200 parts by mass of toluene was added, and the solution was stirred for 10 minutes at room temperature using an ultrasonic homogenizer (manufactured by Branson Ultrasonics Corporation, model type SONIFIER 450) to prepare an emulsion. The adjusted emulsion was put in a 5-L reaction vessel equipped with a stirrer and a thermometer, and after nitrogen replacement to make the interior a nitrogen atmosphere, the temperature was raised to 70° C. The polymerization reaction was carried out a 70° C. for 2 hours while stirring. Next, 50.9 parts by mass of N-aminoethylpiperazine was added, then the temperature was raised to 80° C. under a nitrogen atmosphere, and after that, the reaction was carried out at 80°_{C} for 16 hours while stirring to prepare a hollow particle dispersion liquid.

Then, 4000 parts by mass of the resulting hollow particle dispersion liquid was washed by cross-flow washing with 20000 parts by mass of ion-exchanged water using a ceramic filter with a pore diameter of 50 nm, then the washed dispersion liquid was concentrated or ion-exchanged water was added thereto as appropriate such that the solid content be 10% by mass, to prepare a 10 by mass aqueous hollow particle dispersion liquid. In a 7-L stainless steel beaker, 120 parts by mass of Phosphanol RS-710 (manufactured by TOHO Chemical Industry Co., Ltd.) was weighed and dissolved in 2000 parts by mass of isopropyl alcohol. Next, 2000 parts by mass of 10% by mass aqueous hollow particle dispersion liquid was added, and the resulting mixture was stirred at room temperature for 30 minutes using an ultrasonic homogenizer. Then, the dispersion liquid was washed by cross-flow washing with 20000 parts by mass of isopropyl alcohol using a ceramic filter with a pore diameter of 50 nm, then the washed dispersion liquid was concentrated or isopropyl alcohol was added thereto as appropriate such that the solid content be 10% by mass, to prepare a 10% by mass isopropyl alcohol dispersion liquid containing hollow particles.

The resulting hollow particles had an average particle diameter of 83.7 nm, a sphericity of 0.93 and a hollow ratio of as high as 45.7%. Furthermore, the resulting hollow particles had a 3%9 thermal decomposition temperature of as high as 269° C.

### Comparative Example 1

In a 5-L stainless steel beaker, 3600 parts by mass of ion-exchanged water, 1.6 parts by mass of an anionic surfactant (a product name “AQUALON AR-1025”, manufactured by DKS CO. Ltd.), 6.0 parts by mass of sodium p-styrenesulfonate, and 8.0 parts by mass of ammonium peroxodisulfate were added and dissolved. To this stainless steel beaker, a mixed solution of 168 parts by mass of glycidyl methacrylate, 32 parts by mass of 3-methacryloxypropyltriethoxysilane, 4.0 parts by mass of n-octyl mercaptan, and 200 parts by mass of toluene were added, and the resulting mixture was stirred for 10 minutes at room temperature using an ultrasonic homogenizer (manufactured by Branson Ultrasonics Corporation, model type SONIFIER 450) to prepare an emulsion. The adjusted emulsion was put in a 5-L reaction vessel equipped with a stirrer and a thermometer, and after nitrogen replacement to make the interior a nitrogen atmosphere, the temperature was raised to 70° C. The polymerization reaction was carried out at 70° C. for 2 hours while stirring. Next, 35.5 parts by mass of ethylenediamine was added, then the temperature was raised to 80° C. under a nitrogen atmosphere, and after that, the reaction was carried out at 80° C. for 16 hours while stirring to prepare a hollow particle dispersion liquid.

Then, 4000 parts by mass of the resulting hollow particle dispersion liquid was washed by cross-flow washing with 20000 parts by mass of ion-exchanged water using a ceramic filter with a pore diameter of 50 nm, then the washed dispersion liquid was concentrated or ion-exchanged water was added thereto as appropriate such that the solid content be 10% by mass, to prepare a 10% by mass aqueous hollow particle dispersion liquid. In a 7-L stainless steel beaker, 120 parts by mass of Phosphanol RS-710 (manufactured by TOHO Chemical Industry Co., Ltd.) was weighed and dissolved in 2000 parts by mass of isopropyl alcohol. Next, 2000 parts by mass of 10% by mass aqueous hollow particle dispersion liquid was added, and the resulting mixture was stirred at room temperature for 30 minutes using an ultrasonic homogenizer. Then, the dispersion liquid was washed by cross-flow washing with 20000 parts by mass of isopropyl alcohol using a ceramic filter with a pore diameter of 50 nm, then the washed dispersion liquid was concentrated or isopropyl alcohol was added thereto as appropriate such that the solid content be 10% by mass, to prepare a 10% by mass isopropyl alcohol dispersion liquid containing hollow particles.

The resulting hollow particles had an average particle diameter of 80.7 nm, a sphericity of 0.93, and a 3% thermal decomposition temperature of 264° C. Meanwhile, the particles had a hollow ratio of as low as 12.5%.

### Comparative Example 2

In a 5-L stainless steel beaker, 3600 parts by mass of ion-exchanged water, 1.6 parts by mass of an anionic surfactant (a product name “AQUALON AR-1025”, manufactured by DKS CO. Ltd.), 6.0 parts by mass of sodium p-styrenesulfonate, and 8.0 parts by mass of ammonium peroxodisulfate were added and dissolved. To this stainless steel beaker, a mixed solution of 168 parts by mass of glycidyl methacrylate, 32 parts by mass of 3-methacryloxypropyltriethoxysilane, 4.0 parts by mass of n-octyl mercaptan, and 200 parts by mass of toluene were added, and the resulting mixture was stirred for 10 minutes at room temperature using an ultrasonic homogenize (manufactured by Branson Ultrasonics Corporation, model type SONIFIER 450) to prepare an emulsion. The adjusted emulsion was put in a 5-L reaction vessel equipped with a stirrer and a thermometer, and after nitrogen replacement to make the interior a nitrogen atmosphere, the temperature was raised to 70° C. The polymerization reaction was carried out at 70° C. for 2 hours while stirring. Next, 31.9 parts by mass of tetraethylenepentamine was added, then the temperature was raised to 80° C. under a nitrogen atmosphere, and after that, the reaction was carried out at 80° C. for 16 hours while stirring to prepare a hollow particle dispersion liquid.

Then, 4000 parts by mass of the resulting hollow particle dispersion liquid was washed by cross-flow washing with 20000 parts by mass of ion-exchanged water using a ceramic filter with a pore diameter of 50 nm, then the washed dispersion liquid was concentrated or ion-exchanged water was added thereto as appropriate such that the solid content be 10% by mass, to prepare a 10% by mass aqueous hollow particle dispersion liquid. In a 7-L stainless steel beaker, 120 parts by mass of Phosphanol RS-710 (manufactured by TOHO Chemical Industry Co., Ltd.) was weighed and dissolved in 2000 parts by mass of isopropyl alcohol. Next, 2000 parts by mass of 10% by mass aqueous hollow particle dispersion liquid was added, and the resulting mixture was stirred at room temperature for 30 minutes using an ultrasonic homogenizer. Then, the dispersion liquid was washed by cross-flow washing with 20000 parts by mass or isopropyl alcohol using a ceramic filter with a pore diameter of 50 nm, then the washed dispersion liquid was concentrated or isopropyl alcohol was added thereto as appropriate such that the solid content be 10% by mass, to prepare a 10% by mass isopropyl alcohol dispersion liquid containing hollow particles.

The resulting hollow particles had an average particle diameter of 73.5 nm and a 3% thermal decomposition temperature of 268° C. Meanwhile, the sphericity was 0.86, and the hollow ratio was 7.0%, which were low in sphericity and hollow ratio.

### Comparative Example 3

In a 5-L stainless steel beaker, 3600 parts by mass of ion-exchanged water, 1.6 parts by mass of an anionic surfactant (a product name “AQUALON AR-1025”, manufactured by DKS CO. Ltd.), 6.0 parts by mass of sodium p-styrenesulfonate, and 8.0 parts by mass of ammonium peroxodisulfate were added and dissolved. To this stainless steel beaker, a mixed solution of 168 parts by mass of glycidyl methacrylate, 32 parts by mass of 3-methacryloxypropyltriethoxysilane, 4.0 parts by mass of n-octyl mercaptan, and 200 parts by mass or toluene was added, and the solution was stirred for 10 minutes at room temperature using an ultrasonic homogenizer (manufactured by Branson Ultrasonics Corporation, model type SONIFIER 450) to prepare an emulsion. The adjusted emulsion was put in a 5-L reaction vessel equipped with a stirrer and a thermometer, and after nitrogen replacement to make the interior a nitrogen atmosphere, the temperature was raised to 70° C. The polymerization reaction was carried out at 70° C. for 2 hours while stirring. Next, 42.0 parts by mass of 1,3-bis (aminomethyl) cyclohexane was added thereto, and after the temperature was raised to 80° C. under a nitrogen atmosphere. After that, the reaction was carried out at 80° C. for 16 hours while stirring to prepare a hollow particle dispersion liquid.

Then, 4000 parts by mass of the resulting hollow particle dispersion liquid was washed by cross-flow washing with 20000 carts by mass of ion-exchanged water using a ceramic filter with a pore diameter of 50 nm, then the washed dispersion liquid was concentrated or ion-exchanged water was added thereto as appropriate such that the solid content be 10% by mass, to prepare a 10% by mass aqueous hollow particle dispersion liquid. In a 7-L stainless steel beaker, 120 parts by mass of Phosphanol RS-710 (manufactured by TOHO Chemical Industry Co., Ltd.) was weighed and dissolved in 2000 parts by mass of isopropyl alcohol. Next, 2000 parts by mass of 10% by mass aqueous hollow particle dispersion liquid was added, and the resulting mixture was stirred at room temperature for 30 minutes using an ultrasonic homogenizer. Then, the dispersion liquid was washed by cross-flow washing with 20000 parts by mass of isopropyl alcohol using a ceramic filter with a pore diameter of 50 nm, then the washed dispersion liquid was concentrated or isopropyl alcohol was added thereto as appropriate such that the solid content be 10% by mass, to prepare a 10% by mass isopropyl alcohol dispersion liquid containing hollow particles.

The average particle diameter of the resulting hollow particles was 72.6 nm. Meanwhile, the sphericity was 0.85, the hollow ratio was 11.5%, and the 3% thermal decomposition temperature was 245° C. Thus, the resulting hollow particles had low sphericity, hollow ratio, and 3% thermal decomposition temperature.

### Comparative Example 4

In a 5-L stainless steel beaker, 3600 parts by mass of ion-exchanged water, 1.6 parts by mass of an anionic surfactant (a product name “AQUALON AR-1025”, manufactured by DKS CO. Ltd.), 6.0 parts by mass of sodium p-styrenesulfonate, and 8.0 parts by mass of ammonium peroxodisulfate were added and dissolved. To this stainless steel beaker, a mixed solution of 168 parts by mass of glycidyl methacrylate, 32 parts by mass of 3-methacryloxypropyltriethoxysilane, 4.0 parts by mass of n-octyl mercaptan, and 200 parts by mass of toluene were added, and the solution was stirred for 10 minutes at room temperature using an ultrasonic homogenizer (manufactured by Branson Ultrasonics Corporation, model type SONIFIER 450) to prepare an emulsion. The adjusted emulsion was put in a 5-L reaction vessel equipped with a stirrer and a thermometer, and after nitrogen replacement to make the interior a nitrogen atmosphere, the temperature was raised to 70° C. The polymerization reaction was carried out at 70° C. for 2 hours while stirring. Next, 40.2 parts by mass of m-xylylenediamine was added, then the temperature was raised to 80° C. under a nitrogen atmosphere, and after that, the reaction was carried out at 80° C. for 16 hours while stirring to prepare a hollow particle dispersion liquid.

Then, 4000 parts by mass of the resulting hollow particle dispersion liquid was washed by cross-flow washing with 20000 parts by mass of mon-exchanged water using a ceramic fil ter with a pore diameter of 50 nm, then the washed dispersion liquid was concentrated or ion-exchanged water was added thereto as appropriate such that the solid content be 10% by mass, to prepare a 10% by mass aqueous hollow particle dispersion liquid. In a 7-L stainless steel beaker, 120 parts by mass of Phosphanol RS-710 (manufactured by TOHO Chemical Industry Co., Ltd.) was weighed and dissolved in 2000 parts by mass of isopropyl alcohol. Next, 2000 parts by mass of 10% by mass aqueous hollow particle dispersion liquid was added, and the resulting mixture was stirred at room temperature for 30 minutes using an ultrasonic homogenizer. Then, the dispersion liquid was washed by cross-flow washing with 20000 parts by mass or isopropyl alcohol using a ceramic filter with a pore diameter of 50 nm, then the washed dispersion liquid was concentrated or isopropyl alcohol was added thereto as appropriate such that the solid content be 10% by mass, to prepare a 10% by mass isopropyl alcohol dispersion liquid containing hollow particles.

The resulting hollow particles had an average particle diameter of 73.6 nm and a 3% thermal decomposition temperature of 255° C. Meanwhile, the sphericity was 0.84, and the hollow ratio was 16.4%, which were low in sphericity and hollow ratio.

Table 1 below shows the blending composition used to produce the hollow particles and physical properties together. In Table 1, the “amount of amine compound in relation to 100 parts by mass of total of (meth)acrylic-based reactive monomer” specifically means the “amount of amine compounds used in relation to 100 parts by mass of the total of: (meth)acrylic-based reactive monomers having an epoxy group and (meth)acrylic-based reactive monomers having a silyl group”.

In Table 1, the term “active hydrogen contained in amine compound” in “Proportion of active hydrogen contained in amine compound in relation to glycidyl groups contained in (meth)acrylic-based reactive monomers” means hydrogen atoms contained in amine compounds that react with glycidyl groups contained in (meth)acrylic-based reactive monomers.

Furthermore, “Proportion of active hydrogen contained in amine compound in relation to glycidyl groups contained in (meth)acrylic-based reactive monomers” specifically means a value calculated by dividing “the number of moles of all active hydrogen contained in blended amine compounds” by “the number of moles of all glycidyl groups contained in the blended (meth)acrylic-based reactive monomers” and then multiplying the resulting value by 100, and the unit thereof is “%”. As a reference, a method for calculating “the proportion of active hydrogen contained in an amine compound in relation to glycidyl groups contained in a (meth)acrylic-based reactive monomers” in Example 1 is shown below.

First, “the number of moles of all active hydrogen contained in the blended amine compound” in Example 1 was calculated by the equation below.

“Number of moles of all active hydrogen contained in piperazine”

−=[(Parts by mass of piperazine)×(Number of active hydrogen per molecule of piperazine)]/(Molecular weight of piperazine)=[(50.9)×(2)]/(86.1)=1.18(mol)

Next, “the number of moles of all glycidyl groups contained in the blended (meh) acrylic-based reactive monomers” in Example 1 was calculated by the equation below. It should be noted that since 3-methacryloxypropyltriethoxysilane does not contain glycidyl groups, it was not considered in the equation.

“Number of moles of all glycidyl groups contained in glycidyl methacrylate”

=[(Parts by mass of glycidyl methacrylate)×(Number of glycidyl groups per molecule of glycidyl methacrylate)]/(Molecular weight of glycidyl methacrylate)=[(168)×(1)]/(142.2)=1.18(mol)

Accordingly, the “Proportion of active hydrogen contained in amine compound in relation to glycidyl groups contained in (meth)acrylic-based reactive monomers” in Example 1 was calculated as 100%.

TABLE 1

| | | | | Ex. | Ex. | Ex. | Compar. | Compar. | Compar. | Compar. |
|---|---|---|---|---|---|---|---|---|---|---|
| | | | Unit | 1 | 2 | 3 | Ex. 1 | Ex. 2 | Ex. 3 | Ex. 4 |
| Blending | (Meth)acrylic-based | Glycidyl methacrylate | Parts | 168 | 168 | 168 | 168 | 1.68 | 168 | 168 |
| composition | reactive monomer | | by | | | | | | | |
| | having epoxy group | | mass | | | | | | | |
| | (Meth)acrylic-based | 3-Methacryloxypropyl- | Parts | 32 | 32 | 32 | 32 | 32 | 32 | 32 |
| | reactive monomer | triethoxysilane | by | | | | | | | |
| | having silyl group | | mass | | | | | | | |
| | Dispersion aid | Sodium p- | Parts | 4.0 | 6.0 | 6.0 | 6.0 | 6.0 | 6.0 | 6.0 |
| | | styrenesulfonate | by | | | | | | | |
| | | | mass | | | | | | | |
| | Chain transfer agent | n-Octyl mercaptan | Parts | 4.0 | 4.0 | 4.0 | 4.0 | 4.0 | 4.0 | 4.0 |
| | | | by | | | | | | | |
| | | | mass | | | | | | | |
| | Non-reactive solvent | Toluene | Parts | 220 | 200 | 200 | 200 | 200 | 200 | 200 |
| | | | by | | | | | | | |
| | | | mass | | | | | | | |
| | Anionic surfactant | Aqualon AR1025 | Parts | 1.6 | 1.6 | 1.6 | 1.6 | 1.6 | 1.6 | 1.6 |
| | | | by | | | | | | | |
| | | | mass | | | | | | | |
| | Polymerization | Ammonium | Parts | 4.0 | 8.0 | 8.0 | 8.0 | 8.0 | 8.0 | 8.0 |
| | initiator | Peroxodisulfate | by | | | | | | | |
| | | | mass | | | | | | | |
| | Aliphatic amine | Ethylenediamine | Parts | 0 | 0 | 0 | 35.5 | 0 | 0 | 0 |
| | compound | | by | | | | | | | |
| | | | mass | | | | | | | |
| | | Propylenediamine | Parts | 0 | 6.6 | 0 | 0 | 0 | 0 | 0 |
| | | | by | | | | | | | |
| | | | mass | | | | | | | |
| | | Tetraethylenepentamine | Parts | 0 | 0 | 0 | 0 | 31.9 | 0 | 0 |
| | | | by | | | | | | | |
| | | | mass | | | | | | | |
| | Cyclo ring-containing | 1,3-Bis(aminomethyl)- | Parts | 0 | 0 | 0 | 0 | 0 | 42.0 | 0 |
| | amine compound | cyclohexane | by | | | | | | | |
| | | | mass | | | | | | | |
| | Aromatic ring- | m-Xylylenediamine | Parts | 0 | 0 | 0 | 0 | 0 | 0 | 40.2 |
| | containing amine | | by | | | | | | | |
| | compound | | mass | | | | | | | |
| | Heterocyclic amine | Piperazine | Parts | 50.9 | 0 | 0 | 0 | 0 | 0 | 0 |
| | compound | | by | | | | | | | |
| | | | mass | | | | | | | |
| | | N-Methylpiperazine | Parts | 0 | 41.4 | 0 | 0 | 0 | 0 | 0 |
| | | | by | | | | | | | |
| | | | mass | | | | | | | |
| | | N-Aminoethylpiperazine | Parts | 0 | 0 | 50.9 | 0 | 0 | 0 | 0 |
| | | | by | | | | | | | |
| | | | mass | | | | | | | |
| | Dispersion medium | Ion-exchanged water | Parts | 3600 | 3600 | 3600 | 3600 | 3600 | 3600 | 3600 |
| | | | by | | | | | | | |
| | | | mass | | | | | | | |

| Blending amount of amine compound in relation to 100 parts by | | Parts | 25.5 | 28.4 | 25.5 | 17.8 | 16.0 | 21.0 | 20.1 |
|---|---|---|---|---|---|---|---|---|---|
| mass of total of (meth)acrylic-based reactive monomers | | by | | | | | | | |
| | | mass | | | | | | | |
| Proportion of active hydrogen contained in amine compound in | | % | 100 | 100 | 100 | 200 | 100 | 100 | 100 |
| relation to glycidyl groups contained in (meth)acrylic-based | | | | | | | | | |
| reactive monomers | | | | | | | | | |
| Properties | Average particle diameter | nm | 112 | 82.1 | 83.7 | 80.7 | 73.5 | 72.6 | 73.6 |
| | Sphericity | — | 0.96 | 0.94 | 0.93 | 0.93 | 0.86 | 0.85 | 0.84 |
| | Hollow ratio | % | 48.4 | 42.9 | 45.7 | 12.5 | 7.0 | 11.5 | 16.4 |
| | 3% Thermal decomposition temperature | ° C. | 258 | 255 | 257 | 264 | 268 | 245 | 255 |

1. Hollow particles comprising a shell and a hollow portion surrounded by the shell, wherein the shell contains a (meth)acrylic-based resin;
wherein the hollow particles have an average particle diameter of 10 nm to 150 nm;
wherein the hollow particles have a sphericity of 0.90 to 1.0; and
wherein the hollow particles have a hollow ratio of 35% to 70%.

2. The hollow particles according to claim 1, wherein the hollow particles show a 3% thermal decomposition temperature of 245° C. or higher.

3. The hollow particles according to claim 1, wherein the (meth)acrylic-based resin contains a polymer derived from a (meth)acrylic-based reactive monomer having an epoxy group and/or a polymer derived from a (meth)acrylic-based reactive monomer having an oxetane group.

4. The hollow particles according to claim 1, wherein the (meth)acrylic-based resin contains a polymer derived from a heterocyclic amine compound.

5. The hollow particles according to claim 1, wherein the heterocyclic amine compound is at least one selected from the group consisting of piperazine, N-methylpiperazine, N,N′-dimethylpiperazine, N-aminoethylpiperazine, and imidazole.

6. The hollow particles according to claim 1, wherein the shell contains an inorganic component.

7. A dispersion liquid comprising the hollow particles according to claim 1.

8. A coating agent comprising the hollow particles according to claim 1.

9. A heat-insulating film comprising the hollow particles according to claim 1.

10. An antireflection film and an antireflection film-attached substrate comprising the hollow particles according to claim 1.

11. Alight extraction film and a light extraction film-attached substrate comprising the hollow particles according to claim 1.

12. A low dielectric constant film comprising the hollow particles according to claim 1.
